(19) United States
(12) Patent Application Publication
(10) Pub. No.: US 2009/0204547 A1
(43) Pub. Date: Aug. 13, 2009

(54) TRANSACTION MANAGEMENT SYSTEM AND METHOD

(75) Inventor: Nicholas David Wingham Rowan, London (GB)

Correspondence Address: BROOKS KUSHMAN P.C., 1000 TOWN CENTER, TWENTY-SECOND FLOOR, SOUTHFIELD, MI, 48075, US

(73) Assignee: GUARANTEED MARKETS LTD, London (GB)

(21) Appl. No.: 11/569,459

(22) PCT Filed: May 18, 2005
(86) PCT No.: PCT/GB2005/001917

§ 371 Date: Nov. 21, 2006

(30) Foreign Application Priority Data
May 24, 2004 (GB) 0411503.6

(51) Int. Cl. G06Q 30/00

(52) U.S. Cl. 705/80; 705/26

(57) ABSTRACT

A transaction management system manages the purchase of products and/or services by a buyer from sellers. The system comprises: (a) a data store for storing seller data comprising, for each of a plurality of sellers, a seller identifier and seller offer data indicating at least one product and/or service offered for sale (b) a program store storing processor implementable instructions; and (c) a processor coupled to the data store and to the program store for implementing the stored instructions.

Within the program store the stored instructions comprise instructions for controlling the processor to (a) implement a buyer interface to receive a purchase inquiry from a buyer, the purchase inquiry comprising purchase criteria for a plurality of product and/or service requirements including timing and/or geographical relationships therebetween (b) output seller offer data for a plurality of groups of sellers, the sellers of each group together being able to meet the purchase criteria for the plurality of product and/or service requirements; and (c) receive a purchase request from the buyer accepting said offers of the products and/or services from one of the groups of sellers.

### FIELD OF THE INVENTION

The present invention relates to the field of online commerce. In particular it relates to the operation of electronic markets in which there are a plurality of sellers.

### BACKGROUND OF THE INVENTION

Buying and selling online is conducted through a variety of mechanisms for matching the buyer and seller. These mechanisms include online catalogues, auctions, bid/ask systems, aggregating of buyers, request-for-quote services and bulletin board listings. Each mechanism is strong for certain types of transaction and weak for others.

The mechanisms above can be divided between those that allow immediate purchasing of pre-determined goods or services and those that accommodate irregular purchase requests but require more time for a purchase to complete.

An online catalogue of the type accessed at Amazon.com for example allows goods that have been described by the seller to be displayed to buyers at a price set by the seller. Similarly items auctioned on sites such as ebay.com are described by the seller but he then waits to see what price the market will pay for his offering. Bid/ask services such as that operated by Priceline.com and described in U.S. Pat. No. 5,794,207 require buyers to define a specific item or range of items to be purchased, typically an airline ticket between two points in a given date range, then wait to see if that need will be matched from a seller's database of pre-described offerings.

By contrast a buyer accessing a request-for-quote service such as that operated by guru.com is able to define his particular needs of the moment, a day of web design work at a specified location for instance, and then receive quotes from sellers who, having digested his requirements, quote a price at which they are willing to fulfil his need. This is time consuming for all concerned. Buyers must wait for a range of sellers to reply to their request to be sure of a fair price. Sellers must take the time to understand buyers' requirements and bid, knowing they may not be successful in getting the business.

The time consuming nature of online transactions in which the buyer is able to define his exact needs rather than shopping between various options pre-defined by sellers makes existing mechanisms impracticable for many transactions. They include short notice purchases or small purchases where the sum involved does not merit the attention of sellers or the waiting of buyers.

Ideally, in many markets, a buyer would wish to define his exact requirements of the moment and immediately be given a list of sellers specifically available and ready to meet that need. For instance his need might be “I want a temporary secretary to work from 2.00 to 6.00 this afternoon at my office”. He would then wish to see an immediate list of sellers who were (a) qualified to work as secretaries (b) in the vicinity of his office (c) willing to work this afternoon (d) currently willing to accept assignments at short notice (e) currently willing to accept assignments of only a few hours duration (f) could be contacted in time to receive details of this period of work.

Existing mechanisms are of little use to such a buyer. A bulletin board for instance will reveal a list of possible secretaries who can be emailed to see if they meet the characteristics above. An auction would be too time consuming for the buyer who could more easily phone a temporary worker supply agency. An online catalogue that simply allows the buyer to browse a list of offerings is again too time consuming for this buyer. Bid/ask type services require the buyer to input the price he will pay rather than allowing a market rate to be established.

To overcome this gap in the art the present inventor has previously disclosed elements of an online buyer/seller matching system called “GEMs”. Such a system is defined by an ability to take in a buyer's requirements and immediately construct options specific to his needs based on broader inputs from any number of sellers. Any of these options can then be purchased immediately. Such a system could run a plurality of markets in different sectors, for example such markets might include: bicycle hire, hire of a driving instructor or short notice office cleaning services.

FIG. 1. shows the buyer input screen for such a system as completed by a buyer who is seeking to book a temporary secretary. FIG. 2 shows the options returned immediately by such a system. These are not bulletin board style listings showing potential sellers who may possibly be available and possibly be interested in this transaction. They are specific options built around the buyer's inputs priced and ready for purchase.

Such a system holds considerable information about each seller which can be searched in the light of a specific buyer's enquiry. Each seller displayed on the screen represented at FIG. 2 has previously specified parameters within which they are willing to sell. These may include geographical area, period-of-notice for an assignment and length of assignment. This information is stored. All of those parameters are met by this requirement for each seller on the screen. The system has also checked that the seller is showing availability in an online availability diary this afternoon and that their diary of times when they undertake to be reached, for instance by mobile phone text message or email, would allow them to be notified of this transaction in time. The buyer can choose any one of these sellers and the system will inform the individual of the assignment regarding them as sold and making the required amendments to their availability diary.

Aspects of the GEMs system have been disclosed in publications by the present inventor. An overview of one embodiment of such a system will now be provided to illustrate one form of underlying architecture for the present invention. Referring first to FIG. 3, this shows a generalised embodiment 300 of a system that might underlie the present invention. Such a system would run a number of markets in different sectors, examples of sectors include: secretarial services, office rental and vehicle hire.

A Communications Network 303 is connected to Seller Terminals 301a and b and Buyer Terminals 302a and b and to a System Communications Interface 304. The communications network may comprise any conventional communications network such as a telephone network or the Internet. The communications network couples the buyer and seller terminals to the System Communications Interface 304 to provide user interfaces to the system to allow buyers and sellers to request and execute transactions using the system.

The Communications Interface 304 is coupled to a Communications Processor 305 which creates screens and messages for communicating with buyer and seller terminals 302 and 301. The communications processor is connected to an Application Processor 306 for providing transaction management applications. Application Processor 306 is also coupled to a system service provider terminal 308 to allow a system service provider/operator direct access to aspects of the system to which access via Communications Network 303 is restricted for security reasons. Thus Service Provider Terminal 308 may be used for system management, account management, program code updating, setting a mark-up on each transaction within the system for operator revenue purposes and similar functions. In an alternative embodiment Service Provider Terminal 308 may be connected through a wider communications medium such as the Internet.

Application Processor 306 is coupled to Data Store 307 storing system-related data. It is also able to communicate with external servers that perform specific additional tasks for the benefit of system users. Thus Application Processor 306 can process data for output to buyer and seller terminals 302 and 301 and Communications Processor 307 can access the data to send and receive messages to and from terminals 302 and 301. Thus data in Data Store 307 is indirectly accessible via buyer and seller terminals 302 and 301.

The Communications Interface 304, Communications Processor 305, the Application Processor 306 and the Data Store 307 may all be provided within a single general purpose computer or these functions may be distributed over a plurality of machines in a manner well known to those skilled in the art.

The Communications Network 303 in this embodiment is the Internet to which are coupled Buyer Terminals 302a and b and Seller Terminals 301a and b. Also coupled to Internet 303 is a gateway (not shown) to a mobile phone network 309 (or, more generally, any mobile communications network) which communicates with a Mobile Station 311, such as a phone handset, using base transceiver station 310.

FIG. 4. illustrates a preferred embodiment for the system's architecture within a central server. Communications Processor 305 interacts with Communications Interface 304 to receive inputs and forward output communications to buyers and sellers. Application Server 306 contains software modules allowing new users accessing the system through the communications network to register as sellers 421 or buyers 422, or both. Transaction Management Module 423 extracts market rules information from the data store to govern information displayed to users in a particular market and the prioritization of searches. Assembly of Options Module 424 receives lists of relevant sellers after a search and applies rules on their filtering and display. In its simplest embodiment this module sends all sellers returned by the search to the Communications Processor 305. Price Construction Module 425 takes the list of sellers produced by

Assembly of Options Module 424 and constructs the unit price at which each seller will fulfill this buyer's specified needs.

Once a buyer has selected a seller he wishes to purchase, Post Sale Management Module 426 compiles the information about the buyer and transaction that is required to inform the seller of all required details of the sale. Payment transfer module 427 ensures value is transferred from buyer to seller according to instructions in the market rules data store. This might involve credit card processing, transfer of digital value, holding sums in escrow or raising of an online invoice. It may entail breaking the transaction down into parts, the completion of each triggering part payment. Typically this could be achieved by means of a timesheet signed by buyer and seller using their system passwords at the end of each week of a booking. All these processes will be familiar to one skilled in the art and can be performed by widely available software.

User Maintenance Module 428 applies rules to the seller and buyer data store as instructed through the Service Provider Terminal 308. These might include for instance generating email to any user who has not been active in the last 6 months asking that they confirm the email address, and therefore their identity, is still valid.

The Data Store 307 comprises firstly a Database Of Sellers 431. For each seller this includes unique identifying code, name, password, date of birth, contact details, time and date of registration, unit price to be charged to buyers, history of transactions performed plus earnings and details of how payments are to be transferred. For each seller there is additional data stored which can be changed at any time by the seller to which it pertains. Selling Parameters Record 431a stores that seller's preferences for sales, for instance how far from their base travel code they are willing to travel. Seller Availability Record 43 lb stores data input by the seller about the times when they are available to be sold by the system. Seller Contactability Record 431c stores data of the times the seller undertakes to be available for contact by the system and the means by which messages should be sent.

Buyer Database 432 includes information about each buyer on the system. This includes unique identifying code, name, administrator password, headquarters address, time and date of registration, details of other users within the buyer's account allowed to buy on its behalf (named members of staff for example), how payments are to be collected, history of transactions and payments made and the information to be displayed to sellers, for instance showing locations of the buyer's buildings at which they may be required to work.

Transaction Database 433 records details of all transactions on the system. A preferred embodiment of this database includes the following record of any purchase or partly completed purchase: unique identifying code, market in which purchase was made, identity of buyer, identity of seller, time purchase initiated, number of units bought (hours of work for instance), dates units were to be supplied, times of day units were to be supplied, price paid per unit, selling parameters pertaining to this transaction and current status of the transaction which can be only one of the following exemplary list: waiting for seller confirmation/not confirmed/confirmed/in progress/cancelled/completed.

Market Rules Database 434 stores information pertaining to each market sector. Wording and options required to make up screens or messages for the user are extracted by Communications Processor 304.

Market Rules Database 434 also stores rules on admission to a market, for instance “only sellers over 18 permitted” or “no more than 50 hours to be sold by any individual seller in one 7 day period”.

In the above-described aspects of the system communication between the system operator or intermediary and/or buyer and/or seller may be by any convenient communication means, but the system is particularly suited to implementation using an electronic communications network such as the Internet, and Intranet, or an Extranet, or wireless mobile communications.

In preferred embodiments the system is implemented on general purpose computer systems using appropriate software. The software may comprise instructions in one or more of HTML, XML, Java, Perl or other programming languages. Thus aspects of the system may be embodied in computer program code, either as separate applications or parts of a single program. As the skilled person will appreciate, such program may comprise source, object or executable code and code may be implemented on a single machine or shared between different hardware platforms. Such program code may be provided on any conventional carrier medium such as tape, disk, CD-ROM, programmed memory or on an electrical or optical signal carrier. The processor implementable instructions of the buyer and seller terminals may be stored on a network server and provided to the terminal as needed, for example as an Internet data page or web page.

Processes used in such a system will now be described. For ease of understanding the operation of the system will be described with reference to a specific example of the system's use, that of providing temporary secretaries to employers. However use of the system is not restricted to this application.

Listing Goods or Services to be Sold

A new seller will typically enter the system through a portal accessed via the Communications Network 303 and constructed by the Communications Interface 304. This page is able to activate the Seller Registration Module 421. Having taken details of the individual or company, this module then offers a selection of markets in which anyone might register to sell. Thus a new seller might be asked “what do you wish to sell” and then offered a first selection list which includes “my time”. This response prompts a second list from which she chooses “formal temporary work” and then “secretarial work”. A seller can choose to sell in multiple market sectors. A seller may not be named as an individual but simply as “secretary from XYZ Agency”. They are then invited to input the pricing data that allows their price for a transaction for which they are applicable to be constructed. In its simplest embodiment this requires only that they specify a flat-rate price for each unit of sale or part thereof. In the temporary work market the unit of sale is hours.

Thus the system knows the individual's name, contact details, including email address and optional mobile phone number, and that she wishes to sell her time as a temporary secretary at, for example, $8.35 an hour. These details are recorded in seller database 431.

At this point the Seller Registration Module 421 asks the questions that allow this user's parameters for any potential sale to be stored in the Seller Parameter Record 431a. A list of parameters relevant to sales in the secretarial market are accessed from the market rules database 434. They may include:
Geography (for example: “My home postal code is X and I will not work more than Y miles from that point”)
Size of purchase (for example: “I will not accept bookings of less than 4 hours” or “I will not accept bookings lasting more than 10 working days”)
Period of notice for purchase (for example: “I only accept bookings where I have at least 24 hours notice of the job”)

Additionally the seller may be able to define specific buyers registered on the Buyer Database 432 with whom they are unwilling to trade. This is recorded on the Seller Parameter Record 431 a.

The new seller is then offered a blank diary of time blocks, possibly in half hour increments, covering each day for the remainder of the current week. She can click through to further pages covering following weeks. By selecting certain blocks she is able to select the precise times when she is available to work. This is stored in the Seller Availability Diary 431b. By default this diary remains blank with no availability until the seller has input details of her willingness to work.

In a further embodiment the seller is now presented with a second set of diary pages and asked to input times when she undertakes to be contactable by the system. These are periods when she will be logged on to receive email or will have her mobile phone switched on and about her person to receive text messages. This data is stored in the Seller Contactability Record 431c.

Thus it will be clear that the Seller Database 431 now holds details of the individual's identity (including password), market or markets in which they wish to sell, their unit price, the constraints on any sale they will accept, the times they are available to sell their chosen goods or services sold by the system and the times at which they can be contacted by the system. Any part of this information can be changed at any time by the seller logging on and triggering the User Maintenance Module 427. This will display current choices stored in the Seller's Parameter Record 431a, Availability Diary 431b and Contactability Record 431c. The seller can then choose to overwrite her current preferences.

The above example pertains to a potential seller wishing to sell their time. It will be clear the architecture described could equally accept listings for other services. For example: load space on trucks, domestic storage capacity, sales of organic produce or childcare. In each case the Market Rules Database 434 would provide a list of relevant parameters to be completed by the seller. An example of the selling parameters by which sellers can define their willingness to sell based on a buyer's specific needs for some further markets will now be given.

| | UNIT | |
|---|---|---|
| MARKET | OF SALE | SELLING PARAMETERS |
| Overnight | Night | Length of stay/time of arrival/time |
| accommodation | | of departure/number of people in |
| | | room/smoker or non-smoker/period |
| | | of notice to hire |
| Hire of | Hour | Distance to buyer/anticipated hours |
| agricultural | | of work within the hire/length of |
| tractors | | hire/period of notice to hire |
| Local | Mile | Period of notice to pick up/distance |
| deliveries | | from seller postalcode to pick up |
| | | point/length of journey/distance |
| | | from seller postalcode to drop-off |
| | | point/weight of object to be |
| | | delivered/size of object to be |
| | | delivered |
| Specially | Kilogram | Smallness of cake/largeness of |
| commissioned | | cake/style of cake (selected from |
| home cake | | drop down boxes)/period of notice |
| baking | | before delivery/delivery method/additional |
| | | trimmings (selected from drop down boxes) |

The Purchase Process

A new buyer accesses the system through Communications Interface 304 and is shown a generic welcome page generated by Communications Processor 305. From this the new buyer is able to trigger Buyer Registration Module 422. This sends pages requesting information, validates that information and uses it to populate a record in Buyer Database 432. Confirmation of the buyer's means to pay may be obtained through a link to an external agency such as a credit card supplier using Communications Network 303 before purchasing is allowed. This process is well known to those in the art.

A buyer wishing, and permitted, to make a purchase can trigger the Transaction Management Module 423. This will offer a page such as that shown in FIG. 1. that establishes the following. (a) What he wishes to purchase (for example: the time of a temporary secretary) This information is sent to the Market Rules Database 434 which provides the parameters which must be defined to enable a search of the Seller Database 431. (b) The quantity he wishes to purchase (for example by defining a period of daily hours which the system can multiply by the number of days input at the next step). (c) The times he wishes to purchase (for example: by defining a start and end date for a booking). (d) The geography in which he wishes the purchase to be realized (for example: place of work is postal code Y).

Transaction Management Module 423 will ensure all required information is in place before beginning a search. Once the required inputs have been completed the Transaction Management Module creates a record on the Transaction Database 433. A unique identifier code for this transaction is established at the time of storage. The Transaction Management Module 423 then initiates a search of the Seller Database 431 based on the buyer inputs. The search is performed by Assembly of Options Module 424. It excludes those sellers who are among any of the following. (a) Not selling the services/goods the buyer wishes to purchase. (b) Not willing to sell in the area defined by the buyer. (c) Not willing to sell the number of units (for example hours) demanded by the buyer. (d) Not willing to sell with the period of notice for this transaction. (e) Not available at the dates and times the buyer requires. (f) Not contactable in the time required before the purchase.

Thus the Assembly of Options Module 424 is able to return a list of any sellers on the database who meet the following conditions. (a) Selling the services or goods required by the buyer. (b) Willing to sell in the geography required. (c) Willing to sell with the period of notice specific to this job. (d) Available for the times and dates required. (e) Contactable in time for this booking.

This list is sent to Price Construction Module 425. In it simplest embodiment, this module looks up the unit price for each seller on the list, such data being held in Seller Database 431 and multiplies it by the number of units for this sale. Alternatively it may use the selling parameters of the present requirement as outlined in the screen shown in FIG. 1, coupled with a list of pricing preferences from each user, to construct a specific price for this one transaction for each seller. It may also add a mark-up input by the system operator through Service Provider Terminal 308. This provides revenue for the market operator and is retained during any subsequent transfer of payment between buyer and seller. Alternatively the market operator might invoice either party for its transaction fee, or subscription fee, at a future date.

This list of options and their prices is stored in the Transaction Database 433 against the unique identifier for this query. If no sellers are retuned the Transaction Management Module 423 creates a message for the buyer suggesting a change of requirements.

The list of sellers and prices thus stored are now sent by the Communications Processor 304 and the Communications Interface 304 to the Buyer Terminal 302. Before doing so Assembly of Options Module 424 may apply rules such as “display in price order from left to right putting identically priced sellers in alphabetical order” or “only display a maximum of 20 sellers on one screen”. Such rules would be input from Service Provider Terminal 308.

One embodiment of such a page is represented in FIG. 2. If the buyer selects “purchase” on any option or options presented to him, that information is stored in the Transaction Database 433. A page of information for the seller has to be completed by the buyer and payment is arranged according to instructions in the Market Rules Database 434 by Payment Transfer Module 427. This module will access proprietary software well known to those in the art such as credit card approval, transfer of digital value between users on the system or invoice generation and return a “payment OK” flag to be recorded on Transaction Database 433.

Once payment arrangements have been confirmed the Post Sale Management Module 426 is triggered. This performs the following tasks. (a) Confirms the seller is still available. If they have removed their availability or been bought by another conflicting buyer since the search showed them to be available the buyer is advised with a message. (b) Removes the appropriate availability from the seller's record in Seller Database 431. (c) Creates a message for the chosen seller revealing the buyer's identity stored in Buyer Database 432 and adding details of his purchase from Transaction Database 432. In a temporary work transaction these would include: place of work, hours of work, days to be worked and information input by the buyer to be passed to the seller. (d) Looks up contact details on the Seller Database 431 and directs the message to email or mobile phone for instance via the Communications Processor 304. (e) Monitors that the seller confirms they will undertake the assignment before the start of work time. If they do not a message is generated for the buyer advising that the seller has not confirmed and the buyer may wish to re-book. (f) Triggers release of payment from escrow funds at a specified point based on rules in the Market Rules Database 434 (for example 48 hours after completion of the transaction). In a temporary work market this would be likely to be based on completed timesheets each of which triggers an invoice. Online timesheets may be based on technology such as Web Timesheet from Adeo Software or the Time product from Artologik Software

It will be appreciated that modules listed above could be combined in practice. Their listing is purely illustrative of the functions to be performed and is not intended to define the system's structure.

Benefits of the System

This is a “spot market” online. Existing systems for buyer/seller matching tend not to allow immediate purchasing from an infinite number of sellers who may have entered the market only minutes earlier. Online bulletin boards offer listings of sellers who may be available for a general need. Internet auctions require time consuming bidding. Using bid/ask systems the buyer must define parameters of the potential purchase which has to be matched by a precise offering defined by the seller.

“GEMs” type markets such as that just described provide a list of named sellers any one of whom can be booked immediately for a buyer's specific requirements. Unlike online catalogues these markets are able to construct a specific offering for a buyer's needs based on much more general inputs by a plurality of potential sellers.

There are potential enhancements to a system as described above that are already in the public domain:

Grading of Sellers Embodiment

In this embodiment User Maintenance Module 428 promotes sellers up a ladder of grades as they complete specified numbers of trades. Buyers can view relevant sellers produced by the search listed by their grades in the market. Grading data is stored on the Seller Database 431. Users may move automatically through grades as the User Maintenance Module 427 periodically sweeps the seller database checking number of units sold in each market.

Market Overview Embodiment

By sweeping details of transactions held in the Transaction Database 433 including the sale price, times, dates and geographical point required by buyer a market overview module would be able to plot trends in the market for users. Anyone defining a market sector, a geographical area and a time period can then see data which might reflect the following. (a) Number of units sold in that geographical area/timeframe. (b) Average price of units in that geographical area/timeframe. (c) Number of sellers listing their availability in that geographical area/timeframe. (d) Range of periods of notice of purchases in that geographical area/timeframe.

It will be appreciated that this enables potential sellers to make decisions about market entry. Established sellers can identify patterns of demand.

WIPO patent application WO 02/091100 discloses in detail a GEMs system that allows the transactions of high grade sellers to be economically underwritten by the system operator. Underwritten transactions might have a monetary amount attached that specifies the maximum that can be spent on a replacement purchase. This document is incorporated herein by way of reference material.

UK patent application 0329203.4 discloses a means of problem resolution when a transaction fails in “GEMs” type markets. This is achieved by (a) ensuring one party will stake their grade in the system on the genuineness of a complaint about the transaction (b) cancelling the present transaction (c) re-booking an alternative provider possibly accessing cash reserved for underwriting transactions (d) requires the guilty party to defend their grade in the system with an account of the problem (e) if resolution between the two parties can not be found with a sole or joint acceptance of responsibility all details of the case are forwarded to an arbitration hub. This document is incorporated herein by way of reference material.

UK patent application 0401570.7 discloses a means of allowing investors to put cash into underwriting transactions or enabling sellers to complete training or purchasing of essential requirements in “GEMs” type markets. This can be achieved through (a) allowing any investor to set up a fund targeted at transactions or sellers defined by sectors in which they sell/grade/base location (b) allowing sellers to view all funds within the system for which they are eligible and select any which they are willing to accept the terms required by the investor (c) ensuring the seller then complies with the investor's requirements for example on availability offered and pricing (d) accessing cash as required within the seller's transaction pattern and ensuring the cost is then added to transactions and repaid to the investor's fund. UK patent application 30 0406076.0 discloses a system and method for allowing sellers in “GEMs” type markets to have multiple levels of control over the terms on which they are available. This document is incorporated herein by way of reference material.

UK patent application 0406076.0 discloses technology allowing sellers in a system of open marketplaces to offer conditional availability. That is, they are only to be considered available for work and to be included in the search for a particular buyer's requirements if the conditions they have attached to that period of availability have been met. Such conditions might include (a) that they not be hired to work at a particular premises or with persons not on their personal approved list (b) that they must have a particular piece of equipment or facility as a condition of being available. This document is incorporated herein by way of reference material.

The present invention specifically relates to a need to compile individualised chains of multiple transactions at the behest of a buyer using GEMs type markets. For the purposes of this document a chain transaction is defined as one or more distinct requirements for purchase that have a relationship defined by time and/or geography. The requirements may be contained within one marketplace or span several.

Examples of Chain Transactions

Specific examples of a buyer's needs that might be served through a chain transaction include (a) “I need three data entry clerks and a software engineer to work at my office for half a day whenever it is cheapest in the next week” (b) “I need a journey of multiple legs to get from a small village near Boston to a house on the outskirts of Birmingham tomorrow and I want to do it whenever I can get a coach with video entertainment on board for the longest part of the journey” (c) “For my farm I need to hire a tractor for a day next week with a hay-rake hired in the morning and a baler hired in the afternoon, the tractor must be compatible with both, I also want all the equipment delivered to the farm” (d) “I will be out of the house all day on Sunday and want my bathroom repainted followed by new tiling laid on the floor, and I will need someone nearby to hold the house keys and hand them over to the decorators and carpet layer” (e) “I need to travel to London to give a presentation to some potential clients, I want to hire an office, a secretary to work at that office, catering for 20 people, a receptionist and a presentation projector which must be delivered to the office and collected at the end of the session, this has to happen over a 3 hour period whenever it is cheapest in the next four weeks” (f) “As a television producer I want to book a 4 hour editing session with my favourite editor next week plus any edit suite in which he is happy to work and an assistant who he is prepared to supervise” (g) “I need a minor operation as soon as possible and will travel anywhere within a 200 mile radius of home to a doctor who will perform it, I will need transport to and from the location and I want a self-catering apartment for two days after the surgery” (h) “my warehouse needs a truck and driver to take some goods to Lincoln, the truck then needs to be met, at an acceptable location with a fork life truck hired, by three smaller vans that will each take part of the load onto its final destination, this needs to happen tomorrow, ideally the transport will be refrigerated at every stage”.

Prior Art

It is known that a variety of methodologies exist that allow online buyers to make multiple purchases at one time. Services such as that provided by www.amazon.com for example allow a user to input a plurality of book titles which can then all be purchased simultaneously. However, the books being purchased are in no way dependant on each other. Similarly, packages of unrelated groceries can be bought online from services such as www.tesco.co.uk . WO 01/027837 discloses a “universal online shopping list” which can shop between online retailers on behalf of a user but, again, the goods being purchased have no relationship to each other. Also, the technology tends towards goods rather than services. Similarly, WO 01/026018 describes an “electronic shopping agent which is capable of operating with vendor sites which have disparate formats”. U.S. Pat. No. 6,643,624 “Method and system for integrating transaction mechanisms over multiple internet sites” uses a matching engine to seek out a buyer's requirements from multiple online sellers and allow simultaneous purchase of all goods that meet the requirements. Again, both the preceding are focused on goods from online retailers and there is no meaningful dependency between purchases.

Other systems provide for a transaction to be linked to some other function, such as payment to an advertiser who directed the buyer to the site at which they purchased. Similarly patterns of linkage between transactions are often established by software working, for example, on behalf of retailers who wish to understand what combinations of products their customers buy. A typical example is offered by Epson and described at www.pos.epson.co.uk/pointofsale/literature/pdf/tmh5000 ii.pdf in April 2004. However, such systems do not provide for making multiple purchases based on any dependency established.

Packages of transactions with limited dependencies can be created by online technology that, for instance, allows a user to “build your own vacation”. An example of this was found at http://www.onlinetravel.com/byo/search.asp on Apr. 22, 2004. Typically, this technology will take in a buyer's desired location and type of hotel then find a suitable place to stay for the period of their choosing starting from a date within a chosen start period and offer a flight between their selected airport to the airport nearest the hotel at either end of the booking. Additional functionality allows the inclusion of features such as a booking on a golf course near the hotel which was offered at www.myrtlebeachtrips.com/reservations/vac_build.html on the same date as above. Likewise, on the same date, individual packages of internet services could be complied and purchased at www.webnetwerk.com/wanna.htm . However, the technology just described is simply slotting together pre-determined offerings which have a pre-determined relationship to each other, you can not for example tell such a system “I want a return flight during a period of accommodation”, nor can you typically specify “I want a double room for the first two nights and then a single room for three more nights at the same hotel”. Because the range of options is limited and the relationships pre-programmed the flexibility is severely limited.

More complex systems such as SABRE (RTM), GALILEO (RTM), AMADEUS (RTM) and WORLDSPAN (RTM) are well established in the art. Originally conceived as bookings systems for airlines to be operated by travel agents they have evolved into international logistics providers which can typically assemble individualised chains of hotels, rental cars, flights and tourist activities for a particular purchaser. However, this technology would not work within “GEMs” type markets, it does not underwrite chains of transactions for example because it assumes all its sellers will deliver on their promises, nor does it construct the small and disproportionately complex parts of a chain such as taxi journeys or independent delivery of objects from an open market. Again, SABRE type systems tend to be structured around pre-determined relationships between standardised offerings. Likewise, travel planning technology such as that offered by the timetables function at http://www.networlrail.co.uk/ in April 2004 relies on point to point matching through a pre-determined route map, it does not allow any seller to enter the market with any departure times at any period of notice on any route.

It is known that supply chain software, particularly Manufacturing Resource Planning (MRP) technology, can make grouped purchases. Typically this will be triggered by monitoring of inventory and the need for replenishment. U.S. Pat. No. 5,884,300 “Inventory pipeline management system” covers a means of automated purchasing of inventory requirements based on a user's needs. U.S. Pat. No. 6,591,243 “method and system for supply chain control” provides for a more sophisticated version of such a system. Similarly, U.S. Pat. No. 6,324,522 “Electronic information network for inventory control and transfer” discloses a method by which multiple vendors can sell to each other based on their comparative inventory levels.

In a related field, technology that plans journeys is known, as is a variant specifically designed for most efficiently scheduling a fleet of vehicles. Examples include the Shortec product from Ortec (US). Similarly products such as PLANZ by Opcom (Australia) are designed to model routes and drop off points typically for a fleet manager.

None of the above provides for the sophisticated needs of chain transactions in “GEMs” type markets. Technology to achieve this is no based on modelling or controlling assets under the control of an operator. It must provide instantaneous purchasing in a marketplace open to any seller. In such markets: (a) it is typically services, or non-standardised goods such as fresh produce, that are traded (b) sellers need to be underwritten to ensure reliability (c) the relationships between a buyer's requirements can not be proscribed in advance (d) because of the low level nature of likely transactions it is important that low level transactions such as delivery and short passenger journeys be constructed as part of a chain while the market for those services remains fully open and competitive (e) patterns of purchasing need to be constructed from infinite variables, not based on a repeatable supply chain which simply needs to be sustained (f) the system itself needs to make assumptions about relationships between transactions and the buyer's requirements because there are so many options and the buyer is unlikely to wish to define each one in a long chain of requirements (g) individual sellers may have requirements about other transactions within a chain in which they are involved.

There therefore exists a need for technology that will work specifically with “GEMs” type markets to (a) pull together chains of transactions from multiple sellers, each free to sell a non standardised offering with individual terms for price construction and availability to buyers in an unrestricted range of market sectors (b) construct underwriting for each chain (c) work with a minimum of inputs from the buyer while ensuring the buyer is presented with chains most likely to meet his requirements (d) respects seller's wishes about other components of a chain in which they may be part (e) provide rescheduling of all or part of the chain if one or more components fail (f) allow chains to be constructed on a “when cheapest” basis within a given timeframe (g) handle the smallest details of a chain such as a seller who will hold housekeys on behalf of a buyer (h) cost effectively manage the process of selecting requirements for a chain when any requirement's search results may vary between thousands of returns and barely any.

### SUMMARY OF THE INVENTION

According to the invention, there is provided a transaction management system for managing the purchase of products and/or services by a buyer from sellers, the system comprising: a data store for storing seller data comprising, for each of a plurality of sellers, a seller identifier and seller offer data indicating at least one product and/or service offered for sale; a program store storing processor implementable instructions; and a processor coupled to the data store and to the program store for implementing the stored instructions, wherein the stored instructions comprise instructions for controlling the processor to: implement a buyer interface to receive a purchase inquiry from a buyer, the purchase inquiry comprising purchase criteria for a plurality of product and/or service requirements including timing and/or geographical relationships therebetween; output seller offer data for a plurality of groups of sellers, the sellers of each group together being able to meet the purchase criteria for the plurality of product and/or service requirements; and receive a purchase request from the buyer accepting said offers of the products and/or services from one of the groups of sellers.

Preferably, the buyer interface is implemented to receive a purchase inquiry for a diverse plurality of product and/or service requirements to be determined by the buyer. Preferably, the buyer interface is implemented across the Internet.

Preferably, the data store is further for storing buyer data comprising, for each of a plurality of buyers, a buyer identifier.

Preferably, the seller data further comprises, for each of the plurality of sellers, a seller grade dependent on at least one of a number of successfully completed transactions involving the seller and a number of disputed problem transactions involving the seller.

In a preferred embodiment, the stored instructions further comprise instructions for controlling the processor to implement a seller interface to receive the seller offer data indicating at least one product and/or service offered for sale from a seller. In this case, the seller offer data may further indicate a plurality of selling criteria, the selling criteria indicating buyers to which the seller will not sell a product and/or service, sellers with which the seller will not be grouped or products or services with which the seller's products and/or service will not be grouped. The seller interface may be further implemented to provide the seller with timing and/or geographical relationship information for their products and/or services that have been purchased, the information providing timing and/or geographical relationships between the seller's products that have been purchased and/or services and other products and/or services. The seller interface is preferably implemented across the Internet.

The buyer interface is preferably implemented to receive at least one timing relationship between any of the product and/or service requirements from the buyer, each timing relationship being one of at, between, before, after, within and during the start and/or end times of at least one other product and/or service requirement. The buyer interface is also preferably implemented to receive at least one geographical relationship between any of the product and/or service requirements from the buyer, each geographical relationship being at or within a defined distance of at least one other product and/or service requirement.

The buyer interface may be further implemented to provide the buyer with a visual representation of the plurality of product and/or service requirements and the timing and/or geographical relationships therebetween.

Preferably, the stored instructions further comprise instructions for controlling the processor to: ascertain compliance data for determining whether each seller in the group of sellers is willing or able to comply with the purchase criteria; and output compensation data for compensating the buyer if said compliance data indicates that one or more of the sellers in the group of sellers is not willing or able to comply with the purchase criteria for purchased products and/or services, such products being unsupported products and/or services. Said compensation data may comprise data indicating a compensating offer of an alternative product and/or service for the buyer, to replace or supplement unsupported products and/or services, and the stored instructions may further comprise instructions for controlling the processor to implement the buyer interface to accept an offer of the alternative products and/or services based on the said compensation data. Said compensation data may also further comprise data indicating compensating offers of alternative products and/or services for the buyer, to replace or supplement requested products and/or services having a timing and/or geographical relationship with the unsupported products and/or services, and for which the sellers are not willing or able to comply with purchase criteria that have changed as a consequence of the timing and/or geographical relationship with the unsupported products and/or services.

The instructions for controlling the processor to output seller offer data preferably comprise instructions for controlling the processor to sequentially search the seller offer data in the data store to ascertain sellers able to meet the purchase criteria for each of the product and/or service requirements having the timing and/or geographical relationships, the product and/or service requirements in smallest and largest markets being searched first and last respectively.

The stored instructions preferably further comprise instructions for controlling the processor to automatically generate further purchase criteria for the product and/or service requirements, the further purchase criteria being timing or geographical limitations based on historical sales or demand data for the respective product and/or service markets. The further purchase criteria are preferably adaptive, being lowered to increase a number of sellers able to meet the further purchase criteria for a product and/or service requirement and raised to reduce the number of sellers able to meet the further purchase criteria for the product and/or service requirement, the lowering and raising of the further purchase criteria being dependant on predefined data stored in the data store.

At least one of the product and/or service requirements may be for transport to and/or from locations that are defined relative to the location of one or more of the other product and/or service requirements. In this case, the instructions for controlling the processor to output seller offer data may comprise instructions for controlling the processor to search the seller offer data in the data store to ascertain sellers able to meet the purchase criteria for each of the transport requirements and, if no sellers are able to meet the purchase criteria for a transport requirement, transform the transport requirement into two or more related transport requirements having purchase criteria that can be met by one or more sellers.

The seller interface may be implemented to receive seller offer data indicating transport offered for sale by a seller, and the seller offer data may comprise a plurality of selling criteria, the selling criteria indicating a geographical area within which the transport may be provided, the selling criteria changing to indicate specific locations at which the transport may be provided once part of the transport has been purchased.

The seller offer data may further indicate a plurality of selling criteria, the selling criteria indicating products and/or services required by the seller for providing the product and/or service offered for sale, the seller's product and/or service requirement having a timing and/or geographical relationship to the products and/or services offered for sale. In this case, the stored instructions may further comprise instructions for controlling the processor to output seller offer data for a plurality of sellers, the sellers each being able to provide products and/or services required by the seller for providing the product and/or service offered for sale.

In a preferred embodiment, the purchase criteria may include a preference for at least one seller or at least one class of sellers from which the buyer would prefer to purchase products and/or services.

According to another aspect of the invention, there is provided a method for managing the purchase of products and/or services by a buyer from sellers, the method comprising: storing in a data store seller data comprising, for each of a plurality of sellers, a seller identifier and seller offer data indicating at least one product and/or service offered for sale; implementing a buyer interface to receive a purchase inquiry from a buyer, the purchase inquiry comprising purchase criteria for a plurality of product and/or service requirements including timing and/or geographical relationships therebetween; outputting seller offer data for a plurality of groups of sellers, the sellers of each group together being able to meet the purchase criteria for the plurality of product and/or service requirements; and receiving a purchase request from the buyer accepting said offers of the products and/or services from one of the groups of sellers.

The invention also provides a computer software product arranged to cause a computer to execute the above method and a computer readable recording medium having encoded thereon at least one program for performing the above method.

The present invention provides for technology adjacent to one or more online marketplaces. This technology is able to (a) take in a list of requirements from a buyer (b) immediately return all the available options for chains of purchases meeting his need ranked by price, date/time or priority based on convenience and the buyer's own preferences (c) allow amendment of chains (d) enable instant purchase of any chain (e) ensure chains are underwritten to ensure that if one seller in the chain fails to deliver as much of the chain as required can be rescheduled at no cost and minimal inconvenience to the buyer.

The present invention takes in a plurality of requirements from a buyer. It uses these to pull together a chain of related purchases either from one system of marketplaces as illustrated in FIG. 5 or from a plurality of marketplaces where “marketplace 1” in FIG. 5 is simply one of many.

These requirements are for purchases in markets with which the invention has a relationship but can be taken in (a) in any order (b) possibly with parameters such as “when cheapest” or “when closest to my requirements” rather than based on specific inputs.

The requirements can be defined relative to each other; in time, for example “I want requirement A to happen during the duration of requirement B or in geography; for instance “requirement C must happen within 2 miles of requirement D”.

Once the buyer has completed a list of requirements and indicated a minimum of relationships between them the processor (a) sorts the numbers of chains contained within the requirements (b) creates an individual grid that will manage the search for each requirement ensuring each stays aligned with the rest as demanded in the buyer's inputs and refine the search as it progresses to ensure minimal use of processing power by avoiding searching for options that would not fit with the way the chain is coming together (c) triggers a search for each requirement on the grid, updating the grid as it does so (d) manages the desires of each potential seller in the chain regarding other components of any chain of which they become part (e) displays the available chains to the buyer.

In addition the system can (a) construct underwriting that spans the entire chain so if one component fails to materialise it, and others which were dependant on it, can be rescheduled if necessary (b) weight the results to favour chains likely to be most convenient for the buyer or closest to his personal preferences.

### BENEFITS OF THE PRESENT INVENTION

The present invention allows chains of requirements to be constructed immediately from markets selling a wide range of ad hoc services and goods from an infinite range of sellers. These markets are considerably more demanding in technology than those for pre-defined travel offerings or bar coded items and involve complex issues such as availability, contactability, reliability, price construction and post-transaction administration. Without the present invention it is not possible to pull together grouped purchases in such markets as efficiently as more standardised commodities are bought in other online marketplaces.

Additionally, the present invention overlies markets that can (a) output information about patterns of localised supply, demand and pricing in any sector (b) allow any seller immediate market entry with issues of reliability resolved using grading or underwriting. Sellers are able to enter the market with complete control over other transactions with which they might become part of a chain. Thus, as demand for any particular component of chain transactions develops, new sellers are likely to be quickly attracted and the supply is able to quickly become more competitive, this leads to better value for buyers.

As new sectors are added to the underlying marketplaces the present invention is able to immediately involve even their smallest offerings in chain transactions. Thus, the present invention is likely to drive activity in the underlying marketplaces. Some sectors may only be viable in the context of a chain transaction, they might include (a) sellers who act as staging points for goods in transit, allowing those goods to remain on their premises until a further stage in their onward delivery is ready (b) individuals who act as holders of keys on behalf of premises locally that need access as part of a transaction that requires access.

The ability to construct chains can be used to overcome problems when a particular individual requirement in a marketplace can't be found. For example, if a buyer is seeking a team of cleaners for a particular week and no cleaning service company can be found to provide the requirement it may be that the present invention will automatically pull together all the requirements from different underwritten sellers on different days who have no sales relationship.

### BRIEF DESCRIPTION OF THE DRAWINGS

FIG. 1 shows a completed buyer input screen within a known online marketplace defined by an ability to take in a buyer's requirements and immediately construct options specific to his needs based on broader inputs from any number of sellers;

FIG. 2 illustrates an exemplary screen returned by such a marketplace in response to the buyer input in FIG. 1;

FIG. 3 is a schematic illustration of the communications links required for this known marketplace and which can form the basis of the system of the invention;

FIG. 4 represents the system architecture within the Application Processor 306 and Datastore 307 for the system of FIG. 3;

FIG. 5 shows the potential relationship between the present invention and one of the market systems described in previous drawings;

FIG. 6 illustrates a possible architecture for the present invention within a dedicated computer server;

FIGS. 7a, 7b, 7c and 7d are a schematic illustration of information held about each market sector within a datastore;

FIG. 8a represents a requirements box in which a buyer inputs a single requirement for purchase while FIG. 8b. shows a completed screen in which a plurality of such boxes have been completed by a buyer;

FIG. 9 illustrates the process by which the present invention might turn the buyer's requirements into a grid which will control the search process;

FIG. 10 shows a graphic representation of the buyer's requirements which might be displayed to the buyer for confirmation;

FIGS. 11a, 11b and 11c demonstrate the potential structure for a grid constructed as a result of a buyer's inputting of requirements;

FIG. 12 is a representation of a Cluster Table constructed alongside the grid above to ensure requirements grouped by geography and/or time within a chain stay aligned as the search progresses;

FIG. 13 represents the process by which the search process for each non-transit requirement within a grid may be conducted;

FIG. 14 illustrates the table of options that is stored as a result of the search for each requirement within a grid;

FIG. 15 shows the process that may be used to search for a transit requirement;

FIG. 16a, 16b, and 16c graphically illustrate various forms of search for a transit requirement; and

FIG. 17 represent the output of chains available for a buyer's requirements.

### DETAILED DESCRIPTION

1) Architecture

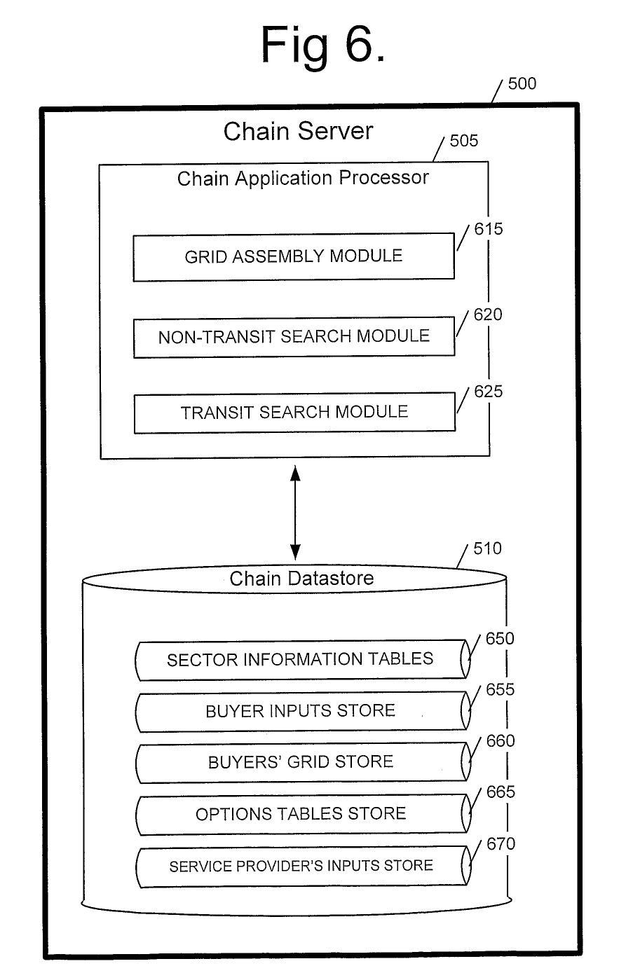

An architecture for the present invention will now be described with reference to FIG. 6. Chain Application processor 505 contains:

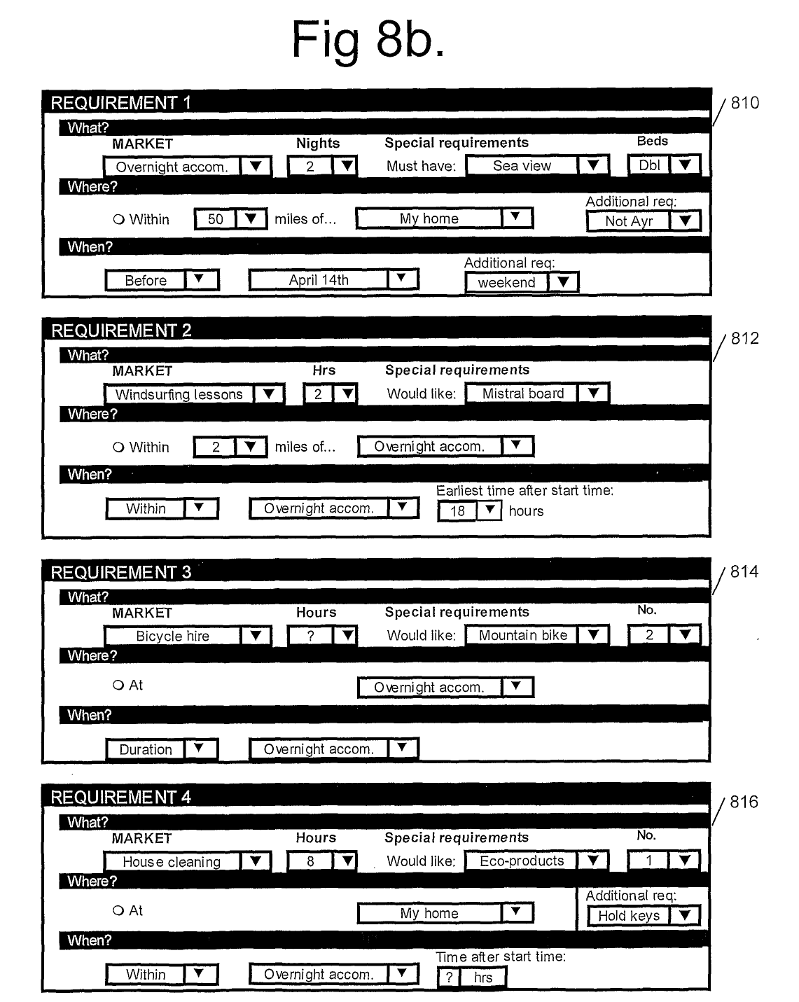

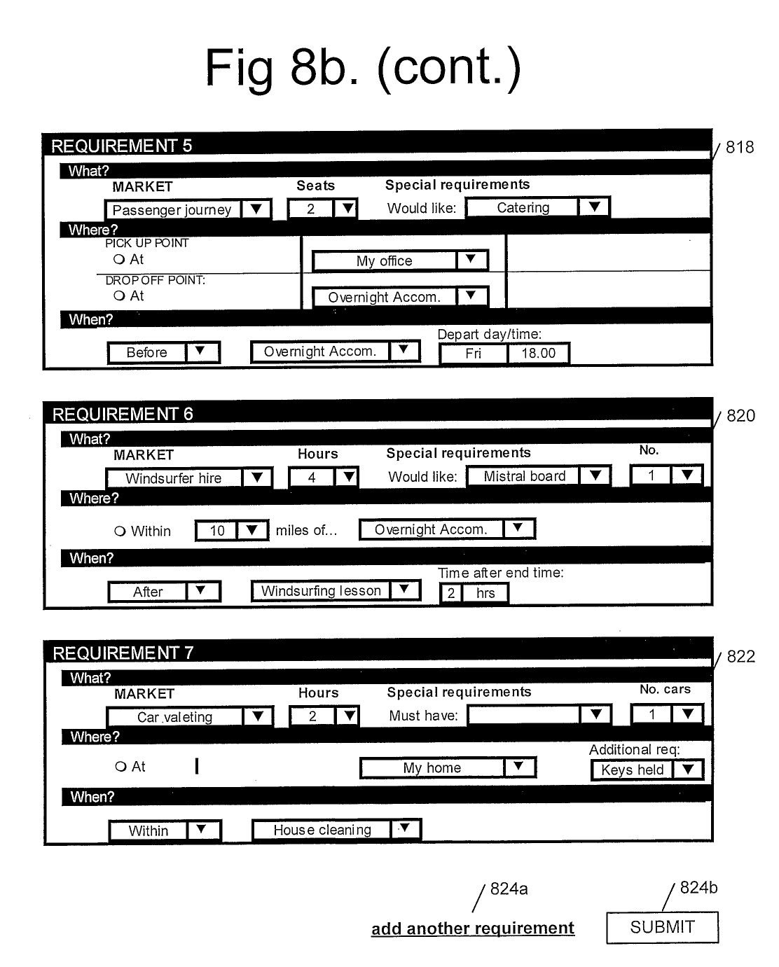

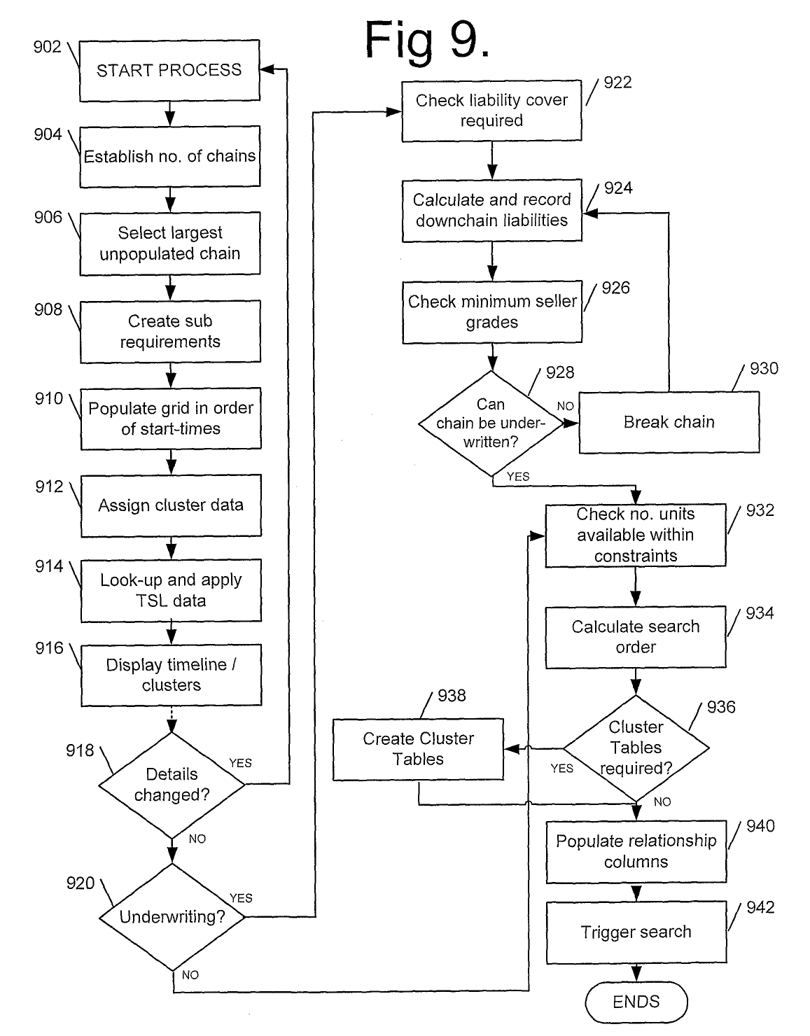

615 Grid Assembly Module; assembles a grid to control the search for a buyer's requirements as illustrated in FIG. 9, it is triggered by the completion of a buyer input page as shown in FIG. 8a and FIG. 8b.

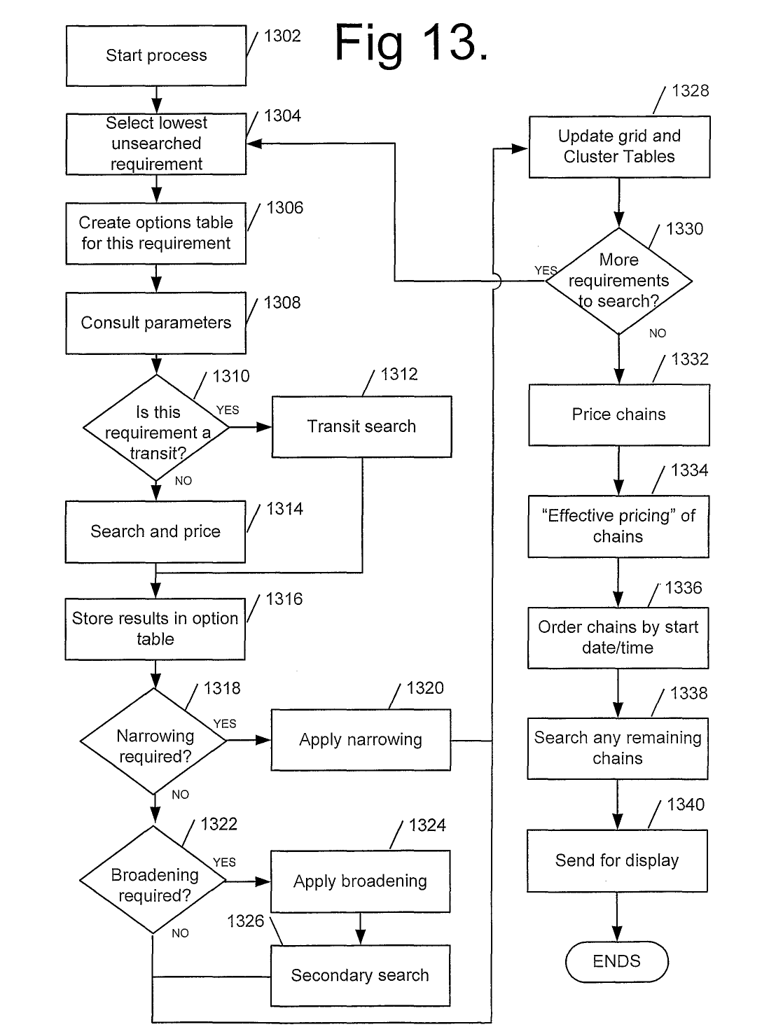

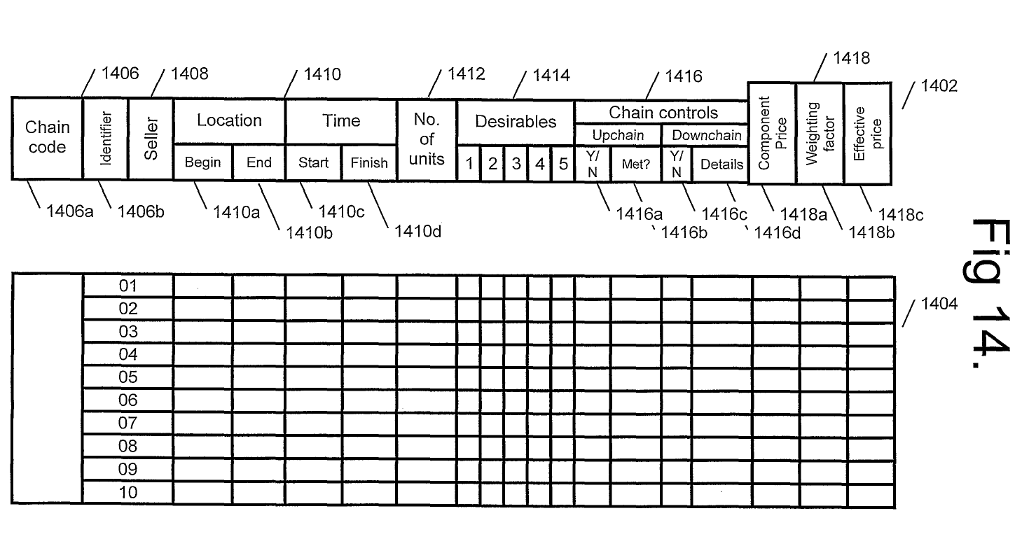

620 Non-Transit Search Module; works once a grid has been prepared to ensure all the requirements that do not involve a journey are searched and the grid updated as the search progresses. This is represented in FIG. 13.

625 Transit Search Module; works within the above module whenever a requirement has a different start and 15 end geographic point, that is it involves the movement of goods or people.

Chain Datasore 510 contains:

650 Sector Information Tables; data about patterns in the marketplaces underlying the present invention which is used to shape the grid based on a buyer's requirements.

655 Buyer Inputs Store; records the buyer's inputs as entered through the screens shown in FIG. 8a and FIG. 8b.

660 Buyer's Grid Store; records the grids assembled by Grid Assembly Module 615.

665 Options Table Store; records each option for a buyer's requirement that is compatible with the grid for that chain of purchases.

670 Service Provider's Inputs; stores certain parameters governing the operation of the present invention that are set by the market operator, input through Service Provider Terminal 308.

2) Information About Each Sector

The present invention requires that disparate goods and services are assembled into sensible chains of transactions with, ideally, the minimum of inputs from a buyer. This process can be refined by tables of information that are stored about each market sector from which offerings may be drawn.

These tables can be used to establish (a) a categorisation for what is being sold in this market that describes its likely relationship to other components in a chain transaction, for example does this sector tend to cover a fixed facility (such as overnight accommodation) to which the buyer will move or is it a mobile facility (such as sales of organic produce) which will typically require delivery to the buyer (b) common-sense limitations that should be applied to the given sector to define times of bookings, for example there is a small section of the recreational diving market that requires night time dives, however a casual buyer who has included a diving session in a chain of requirements should not be offered this option unless he has specified that is what he wishes, a Table of Limitations ensures the components of a chain are sensible (c) underwriting information which can allow the present invention to ensure if any component in a chain transaction fails there are underwriting funds available to reschedule any dependant components and that this facility is as cost effective as possible.

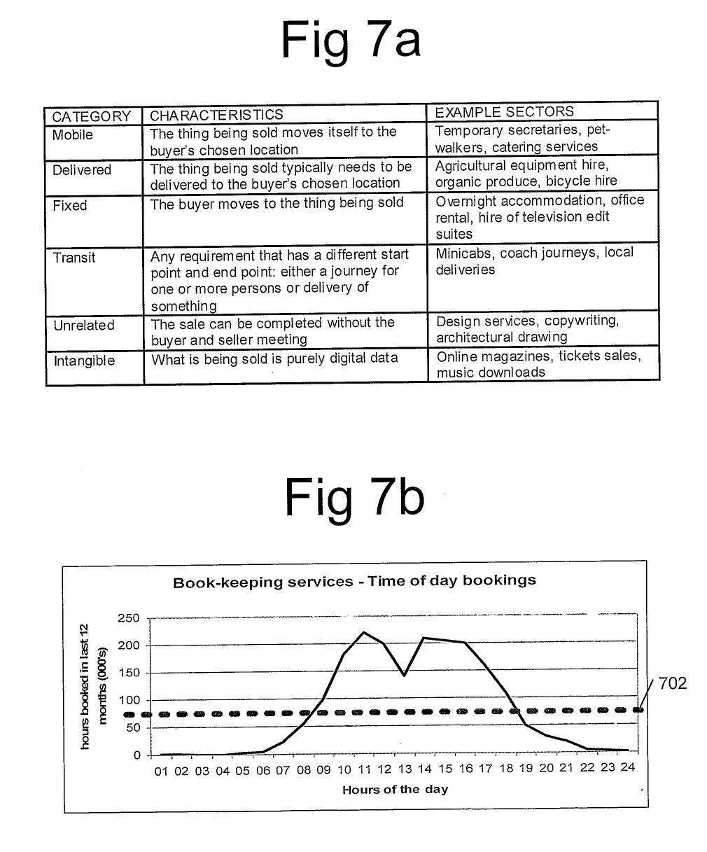

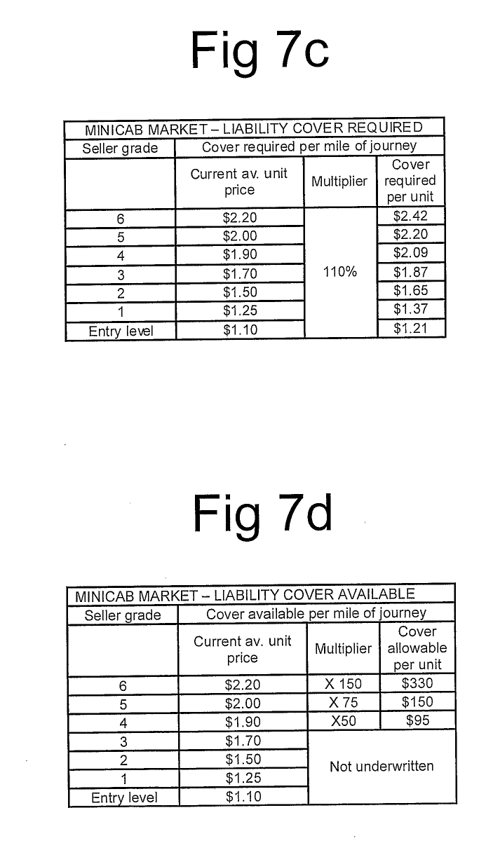

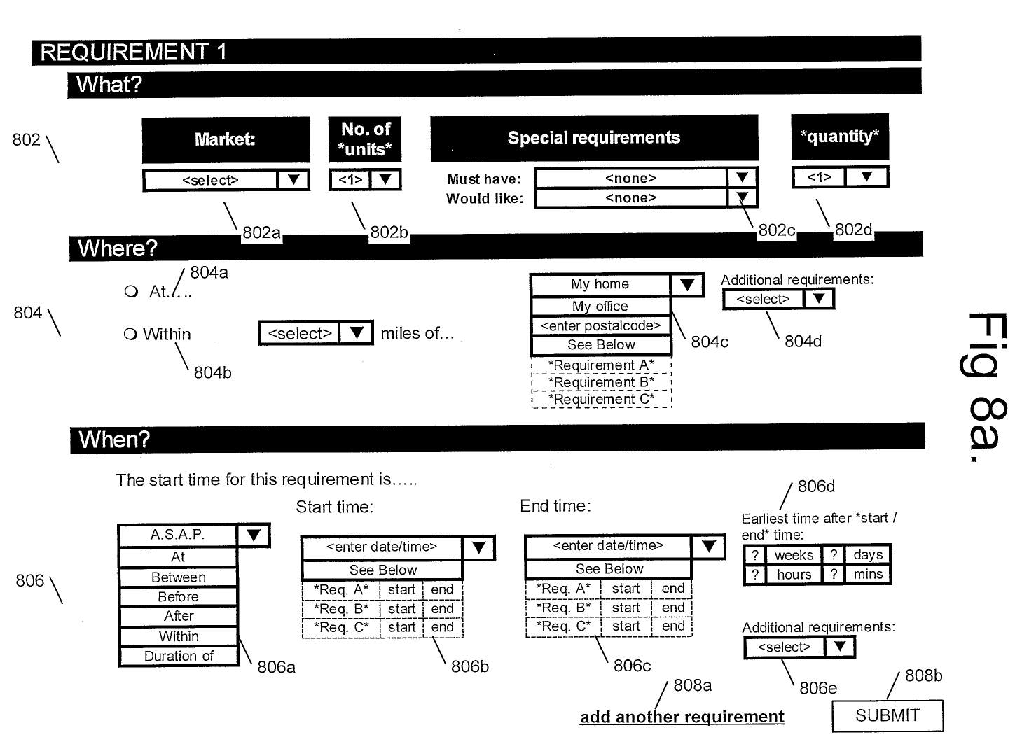

These tables are stored in Sector Information Tables 650 with any additional inputs entered through Service Provider Terminal 308 and will now be explained with reference to FIG. 7a, b, c and d.

FIG. 7a illustrates geographic categorisations, one of which is applied to every sector from which transactions can be drawn. This information is used to cluster transactions together so that, for example, if a chain requires one facility that is “mobile” and another that is “fixed” at the same time, the system can assume the mobile facility is to be delivered to the fixed facility unless the buyer specified otherwise. Thus, if a buyer seeks van hire and industrial storage at a particular location concurrently the search process will know (a) the van hire requires a point of delivery to be established (b) by default it can attach the delivery point to the industrial storage location because that is fixed. This table also allows assumptions to be made about delivery requirements, if a market is classed as “mobile” and the unit of sale is time then the system will assume it requires both delivery and then collection at the end of the booking. If the unit of sale is otherwise, for example “kilos” in the produce market, the system will know the thing being sold is not returned.

FIG. 7b demonstrates a Table of Limitation covering hours of the day for the book-keeping market. It is compiled from data about purchases of book-keeping services over a given timeframe of perhaps one year with each hour of each booking being added to the appropriate columns. Thus it will be seen that the majority of bookings are within office hours with a smaller proportion in the evening and very few during the night-time hours.

Horizontal line 702 across the graph shows a threshold for percentage of hours booked. For example it may be set at 70% meaning that 70% of hours in the graph are above the line and these hours should be considered acceptable to the buyer who has input no specific requirements otherwise. (Alternative means of computing such a formula for acceptable hours will be clear to those skilled in the art). If a chain can not be compiled because there are no hours within the Table of Limitations available then the line might be moved to 80% or 90% so the number of acceptable hours are widened, but only if that is essential completing the chain. Similar tables may be stored for (a) days of the week (b) weeks of the year (c) length of bookings (d) geographic location and multiple other parameters by which market activity can be dissected. Table of Limitations are not applied to market sectors classed as “Unrelated” or “Intangible” because it does not matter to the buyer the exact times or locations at which these sales are completed.

FIG. 7c and 7d relate to a preferred embodiment of the present invention which allows for chains of transactions to be underwritten. That is, if one seller in the chain fails to deliver according to his contract the system itself will, once notified of the problem, automatically replace that seller and reschedule any other components of the chain that have to be altered as a result. It will do this while holding the original price to the buyer by accessing either its own underwriting funds or a pool of cash provided by investors who wish to insure transactions against failure in return for a fee paid relative to (a) the time cash is deducted from the pool for use in this way (b) the sum required. The process by which this might operate is disclosed by the present inventor in patent application GB 0401570.7 as explained earlier in this document.

An example of this process is if a buyer had purchased a haircut with a minicab from her home to the hairdressers, a minicab back and a babysitter to be at home while she was away. It may be that the first minicab failed to appear and the slot at the hairdressers was lost rendering the second cab journey and the babysitter bookings meaningless. As a first step in this situation the system will attempt to retain the rest of the chain and just replace the failed component, that is replace the minicab in time for the hairdressing appointment to be met. If this was not possible and assuming this chain had been underwritten, the system might (a) repeat the search it originally performed for this buyer seeking replacement (b) weight the resulting options to favour those that cause the least deviation from the original chain for the buyer (c) cancel the sellers from the original chain who are no longer required (d) book the new sellers (e) debit the costs from the cash as described above.

Underwriting for a chain can be defined by two parameters applied to each transaction. The first is the likely cost of replacing the seller in the present transaction with another. This is based on (a) the current cost of a unit of sale in the underlying marketplace (b) a multiplier to allow for the likely short notice nature of replacement bookings (c) the number of units in the sale in the specific transaction. As illustrated in FIG. 7c it is likely the figure would change with the grade of seller in a graded market because higher graded providers are likely to be more expensive. The figure for each transaction in a chain can then be totalled to produce the “downchain liability” for each component. Thus, in the example above, the first minicab must bear the cost of rescheduling all the other elements because if it fails and can not be replaced the whole chain may need replacing. The hairdressing appointment need only underwrite the minicab home as a downchain liability.

Thus, once a chain is compiled, each transaction within it has a “Liability Cover Required” figure, that being the estimated cost of rescheduling all the dependant transactions. In an extensive chain this figure could be very large and require cover for a small component which was disproportionate to the value of that component. There therefore needs to be a table of “maximum liability” which specifies the maximum amount a given transaction can underwrite in terms of dependant transactions. Again, this is likely to be relative to the grade of seller with the highest grade sellers able to attract a considerable multiple of the value of each transaction in underwriting cover because they are known to be extremely reliable and the lower grades possibly not being allowed underwriting at all. The total liability a particular seller is allowed to carry might be (a) a fixed figure input through Service Provider Terminal 308 or (b) an ever changing figure based on conditions attached to money made available by investors. A possible embodiment of one iteration of this table is illustrated in FIG. 7d.

Additional tables that enhance the present invention will be obvious from the nature of “GEMs” markets described above. They include a store of future units of availability that has been input by sellers. This is categorised by sector within which sale is offered, number of units of sale available, map references within which sale is offered and times at which sale is offered.

3) Offering a buyer the means to input a chain of requirements

A buyer accessing the present invention inputs their needs by means of a series of requirement boxes. Each allows the user to specify (a) what it is they wish to purchase (b) where they wish to purchase or have delivery arranged (c) when they wish to purchase. Entries do not need exact details specified but can be dependant on each other so, for example, Requirement D might be needed at the location of Requirement B with delivery to coincide with the start time of Requirement E. Once the buyer has completed a series of Requirement boxes, each defining one component in the chain transaction, he clicks “Submit” and the system will build a grid of his requirements and then search them through multiple underlying marketplaces.

The process of a buyer specifying his requirements will now be disclosed with reference to FIG. 8a and 8b. FIG. 8a illustrates one embodiment of a single Requirements Box before it has been completed. FIG. 8b shows a series of boxes after completion just before the “Submit” button is pressed.

A box such as that in FIG. 8a is offered to the buyer as soon as he indicates a desire to input purchase requirements. The first such box offered is very simple, but as he completes boxes his range of options increase as he is offered the opportunity of linking back to earlier requirements by name, for example, to specify an “at the same time as” relationship between two requirements.

The buyer starts by defining his first purchase in section 802. At 802a he inputs the market in which he wishes to purchase, for example “Overnight Accommodation”. At 802b he is asked how many units (or nights of accommodation) he wishes to purchase and enters 2. 802c allows him to input any special requirements from the list of parameters by which sellers are able to describe their offering, a sea view room for example. Input box 802d is asking for the quantity of units he requires and may amend its query and drop down options in the light of the entry in 802a. Thus, in this example it is asking for his bed requirements and he enters “1 double”.

Section 804 needs a definition for the geographic area in which this purchase is to be made. This can be as precise as one postalcode or within an area which might include the entire territory of operation. He selects 804a “at” if he wishes to define a precise location and 804b “within X miles” (X being a figure of his choosing) if he wishes to have wider options returned. At 804c he defines the base location which can be (a) a postalcode or map reference either already known to the system from past inputs or input by the buyer for this transaction (b) a “see below” option meaning the buyer is going to define the location relative to a later requirement in his inputs. Once the first box has been submitted, the second will include “my overnight accommodation” as an option in this selection with subsequent requirements added to the list of options in any successive Requirements Boxes. Area 804d allows further specific location information to be input such as an area to be excluded from the search. Where the market selected at 802a is one classed as “transit” in the table illustrated by FIG. 7a section 804 is provided twice, the first labelled “pick up point”, the second asking for inputs headed “drop off point”. Thus, where the user is seeking delivery of people or objects the system requires a start and end point. Either of both can be connected to another requirement on the list.

Section 806 captures a timeframe within which this purchase is to begin, again either specific or broad. 806a offers a list of time relationships, 806b and 806c allow a timeframe to be defined. (806c does not appear if “At” or “Before” is selected at 806a. 806b does not appear if “After” has been selected.) 806b and 806c allow the user to specify “See Below” meaning he will specify his timeframe relative to another requirement in the list he is building. As with the geography section, as each requirement is input each subsequent Requirement Box offers all previous requirements as identified within 802a as an option. For this section the user is asked to specify whether the relationship is to the start or end time of that requirement. In a further embodiment area 806d allows the user to input a very specific time relationship, for example “I want this requirement to start 2 days and 8 hours after Requirement F has ended”. 806e allows the time requirements to be further defined by days of the week or other parameters. If the market selected at 802a is classed as “transit” section 806 requests allows input of either a departure time or an arrival time.

Having completed this box the user might, by way of example, have defined that he wishes to purchase a double bed for two nights in a sea view room, that it be within 50 miles of his home postalcode and that it be over a weekend within the following 4 weeks. If he now clicks “Submit” button 808b he has simply entered a single requirement and the present invention is not required. However, he has the option of selecting 808a which brings up another blank requirements box and, once that is completed, of continuing the process until he has input all his purchasing needs.

Turning now to FIG. 8b, this shows an example of a completed set of Requirement Boxes. Box 810 is the completed requirements above. Using this facility, the buyer has indicated not only that he wishes the accommodation already mentioned but he wants: (box 812) a windsurfing lesson with a particular kind of board nearby for 2 hours with at least 18 hours to relax beforehand; (box 814) hire of two bicycles at the at the overnight accommodation and for the duration of the weekend; (box 816) his house cleaned for 8 hours while he is away at the overnight accommodation; (box 818) a journey to the overnight accommodation from his office; (box 820) hire of a windsurfer for 4 hours after his lesson with at least a 2 hour gap between; (box 822) his car valeted at home during the time that his house is being cleaned so the cleaner can provide the valet with the car keys.

The buyer may at this point add a further requirement using option 824a or click “Submit” at 824b indicating he has entered all his needs. Some of his inputs may be unspecified, shown as question marks, but he should be confident the system will be able to deduce the required information from his existing inputs.

4) Assembling the Grid for a Chain of Transactions

The process followed when Submit button 824b within the screen represented by FIG. 8b is clicked will now be explained with reference to FIG. 9. This process assembles a grid for each chain transaction required. The grid forms the basis for the multiple searches required to return all practicable chains to the buyer. It is populated with what information is available from the buyer's inputs immediately. It then progressively triggers Assembly of Options Module 424 and Price Construction Module 425 to work on searching individual components while the grid changes with the information received.

Grid assembly starts at step 902 when “Submit” button 824b is pressed. At 904 Grid Assembly Module 615 filters the inputs from the buyer selection screen to establish how many chains, and how many “orphan” transactions are contained within the requirements. An orphan transaction is one which has no relationship specified to any other requirement among the inputs. This is a single component search that can be processed without the involvement of the present invention. A chain is a group of two or more requirements for which a relationship in time (eg: before/after/within) and/or geography (eg: at/within X miles) has been specified.

A buyer's inputs may contain more than one chain. By way of example, the screen represented by FIG. 8b specifies that the housecleaning and car valeting are to be performed at the same time as the weekend away even though the services are to be delivered at a different location. They are thus part of the one chain. If there was no time-based relationship they would be deemed to be a separate chain; they could happen independently of both geography and time of the weekend away chain components and would have their own grid.

Multiple grids can be labelled and stored within Buyers' Grid Store 660 for searching consecutively or all grids within a buyer's inputs can be searched simultaneously. The present embodiment assumes they are stored and worked on in sequence. At 906 the chain with the most components is selected and, at 908, checked for needed sub-requirements, that is if it involves goods or services from markets deemed “delivered” in the categorisation outlined in FIG. 7a then Grid Assembly Module 615 needs to clarify whether (a) the buyer plans to collect and return the object in question or (b) that the grid must include provision for collection and return of the item. This could be achieved by creating a query screen for the buyer. However, in a preferred embodiment Grid Assembly Module 615 assumes it must ensure delivery and collection at this stage.

Thus, the grid is expanded beyond the inputs of the buyer to include delivery and collection of all components that need to be transported if the chain is to be completed. This either involves (a) multiple journeys where the deliveries are unrelated or (b) if there is a common pick up or drop off point; one journey that will collect all the requirements en route. It is thus able to create an additional requirement for example covering “delivery—bicycle” with the hirer's location (currently unknown) as the start point and the eventual location of the overnight accommodation (currently unknown) as the destination with the delivery time to be the start of the overnight accommodation booking. In the present example for instance, Grid Assembly Module 615 would assume the bicycle needs to be delivered to the place of accommodation and collected at the end of the stay; also that although no return journey is specified for the two people involved it should assume they desire one.

Equally it might, unless instructed otherwise, assume that if a service is required at a location from which a passenger journey is requested before the return journey that it needs to construct a way of allowing access to that location, specifically holding keys. This might involve a purchase in a market for “holders”, heavily insured local traders who undertake to retain keys and release them on proof of entitlement issued as part of the contracts for each seller within a chain. A typical rule for key holding might be that the holder has to be available to have the keys dropped off for 24 hours before departure and available for pick up for 24 hours after return. Additionally a delivery from the key owner to the holder might be factored into the requirements but that element is omitted from the present example.

Comparable rules by which additional requirements could be assumed and added to the buyer's inputs will be obvious to those skilled in the art. In each case where such a rule is invoked a new requirement is generated and added to the list

Overview of the Grid:

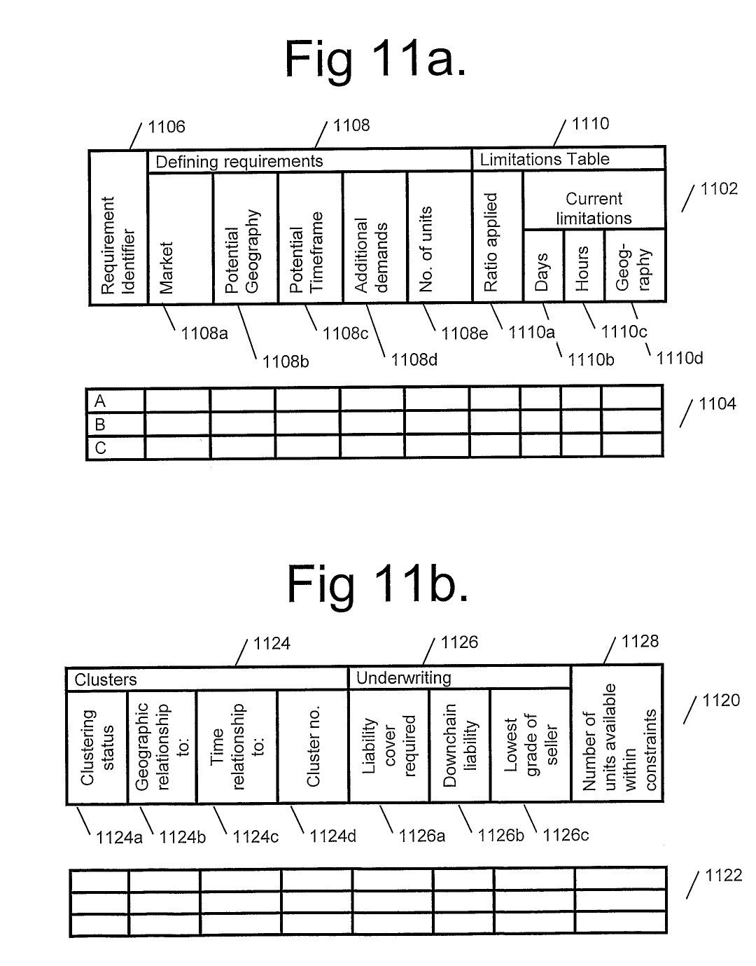

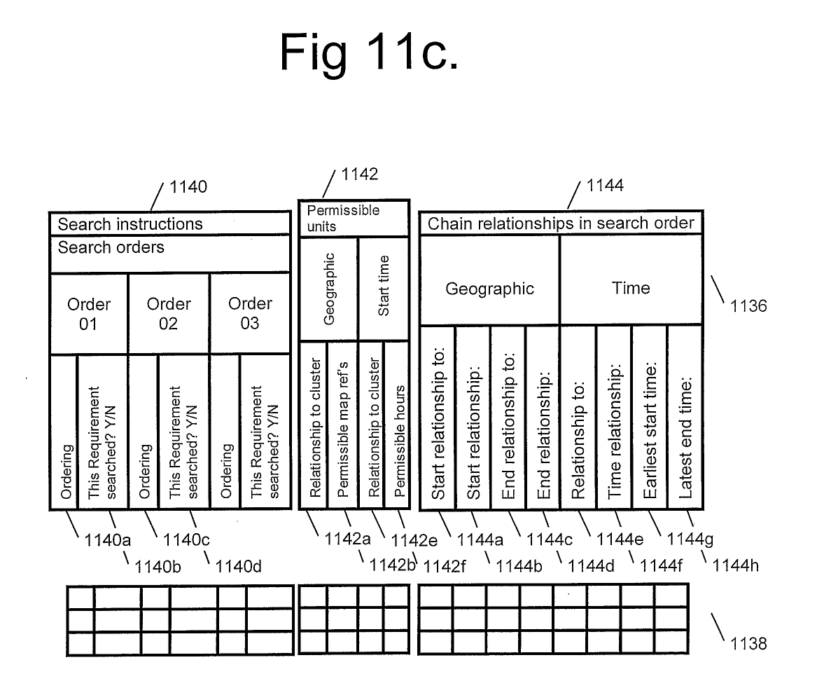

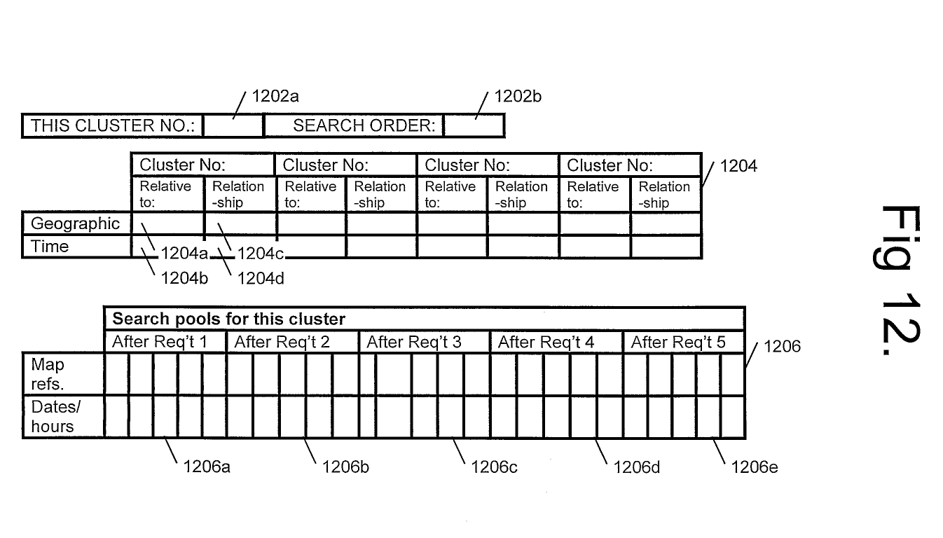

FIGS. 11A, 11B and 11C illustrate one embodiment of the grid that might be used for a typical chain transaction. The part of the grid shown in 11A, in which section 1102 is the heading for database columns and section 1104 represents an infinite number of records, one of reach requirement, stores basic details of the buyer's requirements. The second part of the grid shown in 11B, with section 1120 being a continuation of column headings and section 1122 likewise a continuation of records one for each requirement, further organises the order of components. The final part shown in 11C comprises further columns in section 1136 with their accompanying fields for each requirement in section 1138, covers the relationship between components and the way in which they are to be searched.

Returning to FIG. 9, at step 910 a blank grid is created and all the components of the present chain inserted in order of earliest possible start time within the finished chain. (Where two or more components have the same start time, any that are categorised as “Fixed” in the geographic categorization in FIG. 7a take precedence followed by “Mobile” then “Delivered”, “transit” and then “unrelated” and “intangible”. There may be multiple components of each type with the same start times and these can be arranged in buyer input order within their category).

As requirements are inserted into the first part of the grid as represented by FIG. 11a sections 1106 and 1108 are populated. Column 1106 is simply a letter allocated to each component in order of its insertion and column 1108 contains the scope for fulfilment of each component where it has been defined. At this point, many of the entries in column 1108 will be blank because the buyer's inputs have not defined a specific geography for that specific component.

Thus; column 1108a records the market in which the component is to be purchased (for example “overnight accommodation” or “bicycle hire”). 1108b records every possible map reference in which the transaction required may occur if a geography has been given for this item. If, for example, the requirement is “within 50 miles of my home postalcode” then all map references within that area are input into that field. Column 1108c stores all possible times at which the desired transaction could occur, that is every start time that would provide the number of units required while still being within the parameters of the buyer's inputs.

Thus, when the requirement is “one two night weekend within the next four weeks starting at 18.00” it takes 18.00 every Friday for the next four weeks as an acceptable start date. In column 1108d additional requirements stipulated by the buyer are stored, for example if they wish to stay in accommodation with a sea view room, rent a double room or have selected any other parameter which sellers may indicate to be a property of their offering. These factors can have been defined as either must-haves, that is options without them are excluded, or “desirables”, options with them are to artificially boosted up the final display of available chains but the search can include options without those factors. This column may also store requirements controlling grouping of units by time, for example specifying maximum length of shift in a requirement involving multiple shifts of work, or geography, for example ruling that certain map references are to be excluded from the search. Column 1108e stores the number of units of sale required for this requirement.

Forming Clusters Within a Chain of Transactions

It is now desirable that Grid Assembly Module 615 break the chain into clusters. A cluster is any distinct group of transactions that is separated by place or time requirements from other transactions within the chain. Creating clusters allows each of these groups to be linked to its own base. Thus, if a buyer's inputs mandated that transactions X, Y and Z are to happen at one location while transactions A, B and C are to happen at another “within 40 miles of that location”, A, B and C have to form a different cluster because if they are simply searched consecutively with no link to a common base, A might be 40 miles from the location in one direction while B is 40 miles in another direction.

Therefore, at step 912 within FIG. 9, each market recorded in column 1108a is looked up in the table illustrated by FIG. 7a and the appropriate entry recorded in column 1124a. The number of clusters can then be computed by applying the following steps:

(a) to populate column 1124b (i) look up all transactions deemed “fixed” and enter that requirement's identifying letter from column 1106 in the row for that component (ii) look up all transactions deemed “mobile” or “delivered” and record the location to which they relate, this can be either a letter identifying another requirement, the system aiming to relate each requirement to the earliest possible “fixed” transaction in the chain while remaining within the buyer's inputs, or an independent map reference for example where “my home” was the buyer's geographic input. Any transactions deemed “transit”, “intangible” or unconnected” are geographically fluid and are left blank.

(b) to populate column 1124c; look up the time relationship for each requirement, this can be either (i) an identifying letter from another transaction in the chain, by default the link is made the most relevant “fixed” transaction, again Grid Assembly Module 615 seeks to link each requirements to the earliest possible “fixed” component that is possible within the buyer's inputs, or (ii) a specific date/time input.

(c) the rules for populating column 1124d are as follows; all rows with non-conflicting entries are grouped into one cluster, anytime a row contains a new combination of inputs that is numbered as a new cluster. The presence of a blank cell does not create a new combination and is ignored.

Thus, in the present example, key elements sorted by cluster would look like this (for simplicity many sub-requirements have been omitted):

| | | | 1124b | 1124c | |
|---|---|---|---|---|---|
| | | 1124a | Geographic | Time | 1124d |
| | | Clustering | relationship | relationship | Cluster |
| REQUIREMENT | | status | to: | to: | No. |
| A | Buyer journey to | Transit | — | D | 1 |
| | accommodation | | | | |
| B | Bicycle hire | Delivered | D | D | 1 |
| C | Delivery of bicycle | Transit | — | D | 1 |
| D | Accommodation | Fixed | D | D | 1 |
| E | Windsurfing lesson | Fixed | D | D | 1 |
| F | Windsurfing hire | Fixed | D | D | 1 |
| G | Buyer journey home | Transit | — | D | 1 |
| H | Collection of bicycle | Transit | — | D | 1 |
| I | Home cleaning | Mobile | Home | D | 2 |
| J | Car valeting | Mobile | Home | D | 2 |

At step 914, limitations data is applied to each transaction in the chain. This is the “common sense” restrictions to be further imposed on each transaction to avoid a freak result such as leisure accommodation being offered in an industrial estate or windsurfing lessons being offered at night. There may be sellers offering this facility but Grid Assembly Module 615 needs to assume the majority of buyers will not wish to purchase such market oddities unless they have specifically indicated otherwise. Column 1110 in FIG. 11a is now populated by looking up (a) the current ratio of limitations to be applied in the relevant market indicated in column 1110a, said information being stored in Service Provider's Inputs Store 670 (b) the current figures for that ratio in this market as stored in Sector Information Tables 650 and exemplified in FIG. 7b. Column 1110b and 1110c contain all the hours within each day which are above the minimum ratio as stipulated within Sector Information Tables 650. Column 1110d is populated by all the map references within the appropriate row in column 1108b that clear the threshold required by the ratio in any geography limitations table for the appropriate market.

Assembling a Graphic Representation of a Chain Transaction

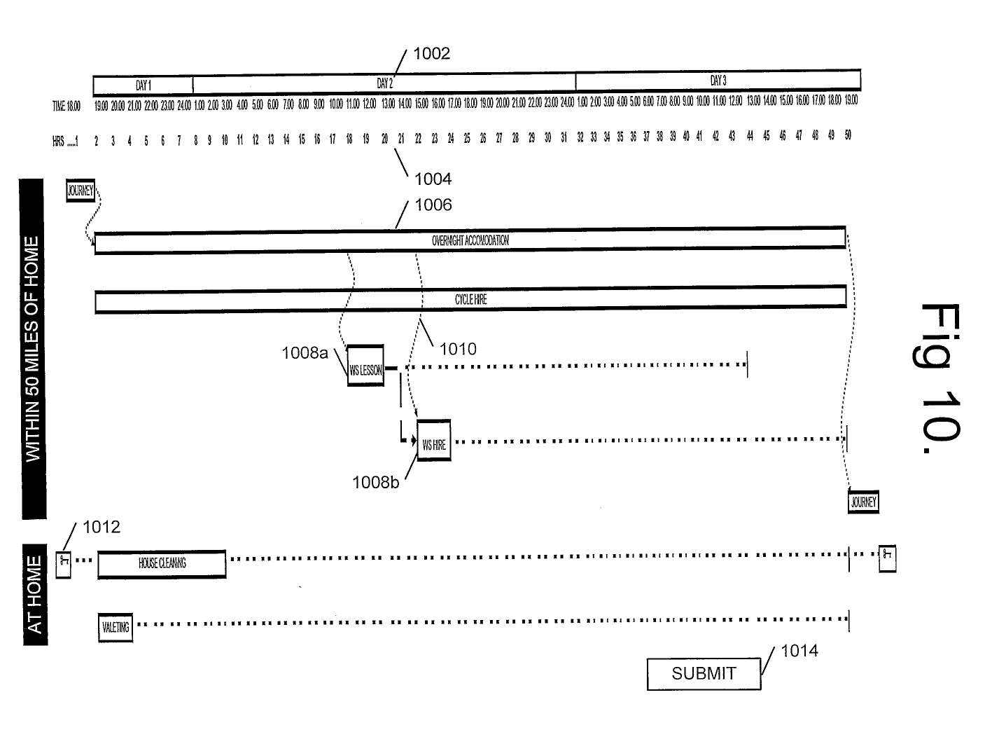

At step 916, Grid Assembly Module 615 may now output a cluster and timeline diagram to the buyer for confirmation. This is particularly important if sub requirements, such as deliveries or journeys between locations, have been added. Said diagram is illustrated by the screen in FIG. 10. Its creation is based on rules applied to the buyer's requirements. These rules may include:

(a) locate the geographically fixed requirement in a cluster (if more than one, use the first one input)

(b) map it onto a grid of hours with the number of hours required boxed

(c) if the time at which the requirement may happen within the cluster is fluid map with a dotted line all the hours at which the requirement may be occurring

(d) repeat this will all requirements, mapping their relationship to each other as follows:

| TIME BASED | |
|---|---|
| RELATIONSHIP | |
| TO BASE | DISPLAY OF BOX FOR THAT COMPONENT |
| Within | Centred among the requirement which it is to be |
| | within |
| For duration of | Identical size to the defining requirements |
| Before | To the left - earliest first, identical start times |
| | below each other in order of booking by user |
| After | To the right - latest start time last with identical |
| | start times below each other |
| Overlap | Centred on left-hand side of the base display |
| beginning | |
| Overlap end | Centred on right-hand side of the base display |
| Overlap both | Centred on base but extending beyond each side |

(e) arrange requirements in chronological order of earliest start times (where two start times coincide place in order of buyer inputs)

(f) number all the hours covered by the possible timespan within which all transactions can be completed

(g) group requirements by clusters with geography marked and insert arrows linking geographic relationships between requirements within clusters

With reference to FIG. 10 such rules should produce the following features by way of example. Section 1002 is the timeline of events by day/hour. 2004 indicates the scale of elapsed hours within the chain. 1006 illustrates a fixed requirement and the time within the total bookings which it should cover. 1008a and 1008b are dependent requirements within a cluster, the block indicates the number of hours duration of that requirement and the dotted line to its right the full time within which the requirement is allowed to occur. 1010 shows a line to a dependent requirement signifying a geographical relationship. Box 1012 shows the key holding facility near the home that will be built into the chain.

Using the screen represented by FIG. 10 the buyer may be able to select any component and click to bring up a box of information that includes (a) their original inputs (b) limitations or other data added by Grid Assembly Module 615. Within this box the buyer is able to make the following changes to any requirement; (a) cancel it (b) change the inputs (c) add an additional component related to the one highlighted (d) release the Table of Limitations ratio to show they do not want limitations imposed. At step 918 the timeline is received back from the buyer who has clicked “Submit” button 1014. If any one of (a), (b) or (c) has been performed, steps 902 to 918 are repeated with step 908 ensuring there is no re-inserting of removed components. If (d) alone has been selected for any option the ratio in column 1110 for that component is changed to 100% and the following three columns are cleared.

Underwriting a Chain Transaction

Once a timeline is accepted by the buyer, Grid Assembly Module 615 might check at step 920 if the chain is to be underwritten; that is, is the buyer to be offered a guarantee that if any part of the chain fails and he notifies the system of this there are funds available to enable the system to (a) replace that failed component (b) reschedule any further parts of the chain that might have become redundant, or require changing, because of the failed component. Thus, if for example, the accommodation booked in the present transaction suddenly becomes unavailable after booking ensuring the transaction as booked still happens requires (a) new accommodation (b) a new delivery point for the hired bicycle, which may entail additional charges, or a new hire if the replacement accommodation is elsewhere (c) possibly a new windsurf lesson if the accommodation has to be at a different location (d) a change in the journey home (e) if the accommodation was based on highly specific, and hard to meet, requirements then the weekend itself may need to be rescheduled because a replacement is not available within the same weekend, in that case the housecleaning and car valeting will also need to be rebooked because they have a relationship with the accommodation.

Underwriting is dependant on (a) the markets underlying the present invention providing underwriting of transactions and the willingness to underwrite chains of transactions and (b) the present transaction being eligible for underwriting, this may be determined by the level of the buyer in a graded market. Thus a high grade buyer, one who has a track record of completing transactions without complaining unnecessarily, may find future transactions underwritten whereas an untried buyer or one with a history of filing complaints judged to be wilful will not.

Underwriting may be linked to grades of sellers, the higher the grade of seller the more they can be relied on to fulfil their commitments and the greater the liabilities in the event of failure they are allowed to incur. Thus, at step 922, Grid Assembly Module 615 looks up the table represented by FIG. 7c and is able to populate column 1126a in FIG. 11b with the amount of cover required to reschedule each requirement should it fail. The figure in the table is multiplied by the number of units within the requirement. At step 924, column 1126b is populated. This records the amount of liability each requirement must bear if it were to fail and necessitate rescheduling all the transactions further down the chain. This is calculated by starting at the bottom of the grid and progressively totalising the figures in column 1126a into the appropriate row until Requirement A in column 1126b contains the total of all figures in column 1126a. In a preferred embodiment, when two or more requirements are to start at an identical time they each underwrite the other, the total sum being added to each in column 1126b.

At step 926 the Table of Liability Cover Available, as illustrated by way of example in FIG. 7d, is consulted for each market listed in column 1108a. Using the figure against that requirement in column 1126b Grid

Assembly Module 615 checks the lowest grade of seller who is eligible for that level of liability cover. The resulting information is stored in column 1126c. It may be that the figure is so high it is above the level of underwriting to be provided to even the highest grade seller, in which case the appropriate row in column 1126c is left blank.

At step 928 Grid Assembly Module 615 checks for blanks in column 1126c. If there are none the chain is deemed to be underwritten. If there are blanks, at step 930, Grid Assembly Module 615 may look to break the chain into two or more parts in which the components underwrite only those in their own part. Rules by which it might do this include (a) finding the median number of clusters and counting those clusters below that number as a distinct part (b) seeking out transits between fixed transactions and inserting a break at that point as a natural break in the chain (c) only underwriting the more expensive components of the chain (d) only underwriting the requirements with a below median figure in column 1126a (e) withdrawing underwriting from a specified number of requirements at the bottom of the chain (f) ensuring each requirement only underwrites others within its cluster and any transit to another cluster so parts of the chain can be rescheduled but not the chain as a whole. The rule to be applied is stored in Service Provider's Inputs Store 670 and input through Service Provider Terminal 308.

When a chain is broken, steps 924 to 928 are repeated. Thus, the system will constantly reshape the underwriting available until it finds the minimum number of parts that will allow underwriting in current market conditions.

Putting Transactions Within a Chain Into Search Order

It is now desirable that the optimum order in which requirements for this chain be searched is computed. For efficiency, the requirements should be searched in order of thinness of options; that is, the requirement for which there are the least options should ideally be searched first because that is likely to limit the options that need to be searched for the next thinnest requirement, and so on. At step 932, therefore, Grid Assembly Module 615 reads any entries in columns 1108a, 1108d, 1008e, 1110b, 110c, 110d and 1126c to produce a detailed profile of the requirement. It then searches Seller Database 431 for each requirement to find the number of eligible unsold units on offer within those parameters. In a further embodiment it searches for all possible consecutive groups of units, thus if a windsurfing lesson is required for two hours, it counts the number of two hour blocks of availability within the required timeframe, geography and with the requisite additional demands and seller grade. In another further embodiment it might factor in the number of units required; thus, if the buyer seeks “3 van drivers” within one requirement it will count the number of options for hiring such a group rather than just the number of van driver hours available. The total number of available units is then stored in column 1128 within FIG. 11b. In a preferred embodiment any transaction deemed a “transit” is excluded from this process because (a) the market in journeys will contain multiple fluid offerings and therefore requires large amounts of processing to ascertain the number of options (b) the start and/or end points may not be known until options for other requirements have been isolated.

At step 934 the optimum search order based on current information in the grid is input into the grid. Additionally the grid contains provision for further search orders to be stored because there may be a need to change to a different order as the searching of requirements progresses if, for example, options for later requirements are narrowed too far by the first search order. This could happen if the options for a later requirement although large in number are at periods or geographies within the chain parameters that are not compatible with requirements searched earlier. Thus section 1140 of the grid, as illustrated in FIG. 11c, contains storage for a plurality of search orders only the first of which is populated at this stage. To enter the first search order into column 1140a the entries in column 1128 are assigned numbers based on the row with the smallest number being one, the next being two and so on. In a preferred embodiment, “transit” requirements are not numbered and are searched in chronological order at the end of the search. Further columns in section 1140 are populated only once the search process is underway.

Assembling Cluster Tables

More complex chains require an addition to the controlling grid that will keep multiple clusters aligned within the buyer's inputs. Thus at step 936 Grid Assembly Module 615 checks column 1124d for the number of clusters in the present chain. If there is only one the functions of a Cluster Table will already be contained within the grid. If it is more than one, a full Cluster Table for each is required. An embodiment of said table is illustrated within FIG. 12 and will now be explained.

Section 1202a contains the number of the Cluster in terms of the order its first requirement was contained within the buyer input order. Section 1202b contains the cluster's placing when the cluster tables are numbered in order of their first requirement's appearance in the current search order. They are then populated with dependency information such that, as the search for each individual requirement is returned (a) the potential range of options for location/timeframe of that requirement's cluster narrows and (b) the options for all other clusters are narrowed as a result. So, by way of example, as the times at which Cluster A's requirements can be fulfilled are defined, so the other clusters which are defined by their relationship to A are also defined. This requires that the clusters' relationships are plotted in the order that they appear in the search, not in chronological order of requirements.

By way of example. A chain might comprise four clusters, (a), (b), (c), and (d), which, in chronological order have the following time relationships (a) start anytime in the next four weeks with a duration of three days (b) start two days after cluster a ends (c) within next Saturday (d) to start and end anytime within the timeframe of cluster b. Assuming the search order turned out to be the chronological order reversed the start-time relationships—as input in the table illustrated by FIG. 12—between these clusters would be (d) anytime in a period made up of the next four weeks minus the first five days, that being the minimum time it would take cluster a to complete and allow two days to elapse (c) no dependency, the timeframe is independently fixed (b) anytime from the point at which cluster d might start (a) 2 days before cluster b. Similar processes can be carried out for the latest possible end time for each cluster and the geographic relationship.

Box 1204a is populated with the geographic anchor for this particular cluster. This can be either (a) a letter identifying another cluster (b) a specific map reference/postalcode. In box 1204c the relationship with that location is specified such as “within 10 miles”. Box 1204b contains either just the start-time or, in a further embodiment, start and end-time references again as either (a) a letter identifying another cluster (b) a specific time. 1204d then contains the relationship required such as “2 days later” or “within 3 hours”.

Section 1206 contains the combinations of startdates/times and base map references for this cluster after each requirement is searched. Thus, the first requirement, which is the one with the fewest likely options, is searched using the raw data from section the columns represented by FIG. 11a. However, after requirement 1 is searched a list of potential transaction options is produced. By reversing the relationship between that requirement and its cluster, as stored in section 1142 of FIG. 11c, the combinations of time and map reference within which that cluster can now occur can be reduced and all other Cluster Tables updated accordingly. By way of example: assume the requirement is the windsurfing lesson and the relationships to its cluster are (a) date/time: “at least 18 hours after start” (b) geography: “within ten miles of cluster base”. If five possible windsurfing lessons that meet the requirements of the grid are located then the appropriate cluster can only start at a point at least 18 hours before each. These can be converted to specific hours of date/time related to each of the five options. Likewise, in combination with each of the five options there is a radius of ten miles in which the cluster can occur. Each possible combination is input into box 1206a.

After the second search the range of times/geographies for the cluster may have narrowed further and the new combinations are input in box 1206b and so on. As a Cluster Table is updated in this way all the others within that chain also update if they have a relationship with the newly updated cluster defined in section 1204. Thus, if Cluster B has to happen within 2 miles of Cluster A, as section 1206 of A is updated section 1204 of B must ensure section 1206 of B is also updated with the newly narrowed options. This then reduces the list of combinations within section 1206 of those clusters.

Defining Relationships Between Requirements

Returning to FIG. 9, at step 940, the final sections of the grid require populating. Section 1142 determines the times and geographies in which an individual requirement may occur relative to the cluster to which it belongs. This information has already been compiled as part of the construction of the graphical display shown in FIG. 10. Thus if Requirement 7 in Cluster C has to start between 4 hours and 20 hours after the start of Cluster C, to allow for requirements before and after, then the potential hours at which it can occur can be plotted by referencing the timeframe in which the cluster as a whole is permissible. Likewise, the geography of a requirement may be defined relative to the cluster as a whole. If the fixed component of a cluster has to happen within 50 miles of a particular location and a specific requirement has to be within 2 miles of the fixed transaction then the further requirement has a potential geography of any point 52 miles or less from the specified location.

Column 1142a stores the geographic relationship to the cluster base at which the transaction will start. This is expressed as a “plus X miles” formula where X may be zero if the buyer has specified an “at” relationship.

Column 1142b will be used to store the permissible map references that are obtained by (a) reading the permissible base geographies for the relevant cluster in the highest number completed box within section 1206 of the appropriate Cluster Table (b) applying the further limitations in column 1124 to that data. A requirement classed as “transit” will additionally require a calculation for end-point geography. This is stored in columns 1142c and d which are identical to those just described and are not shown. Column 1142e stores the relationship of the earliest possible start time for this requirement to the overall start time of the cluster to which it belongs. This is expressed as a “plus X hours” formula in which X can be zero if the requirement is able to start at the very beginning of the cluster timeframe.

The appropriate row within section 1142 is updated each time the Cluster Table to which that requirement belongs is updated as the search progresses. At this point only the information for the requirement that is number one within the highest numbered of the populated search orders in section 1140 is populated. Section 1144 determines the relationships between individual components in the order of search rather than (a) the random order in which they may have been input by the buyer or (b) the chronological order into which they were arranged by Grid Assembly Module 615 for ease of calculating clustering relationships. This process entails translating the buyer's inputs into a specific relationship for each requirement with a component that will already have been searched. Thus, step 940 starts with the row containing number 1 in column 1140a (or its equivalent for alternative search orders), this row is left blank. The process then moves to the row containing number 2 in the same column. This row is then populated with the information defining Requirement 2 relative to Requirement 1. The geographic relationship is defined in columns 1144a to d and the time relationship in columns 1144e through h.

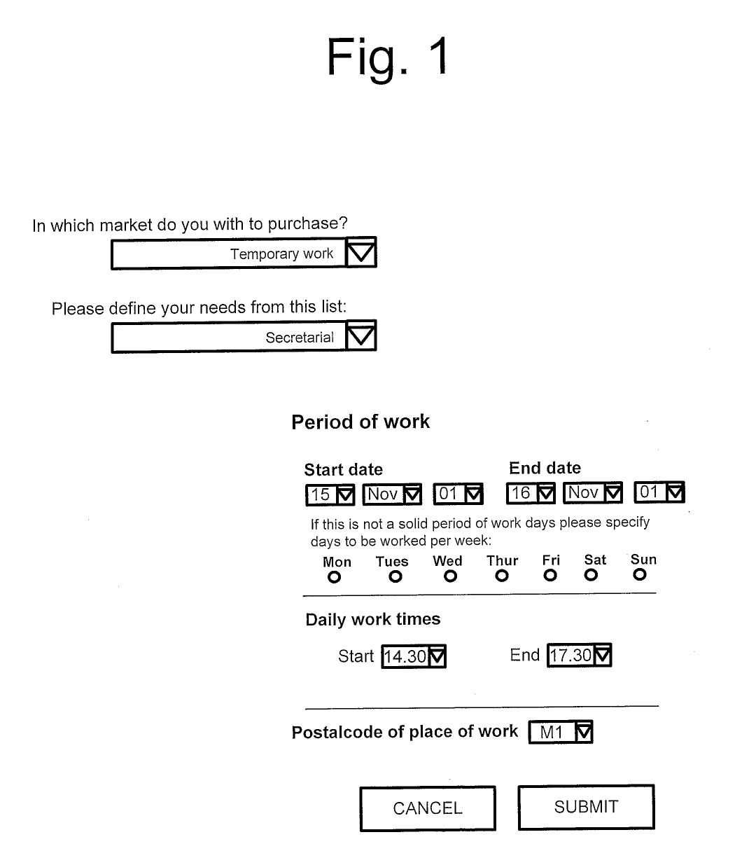

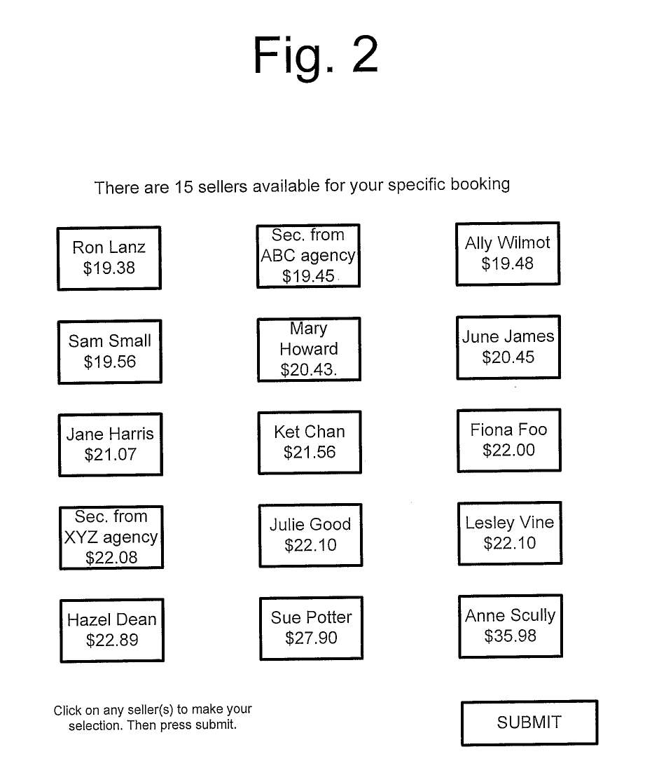

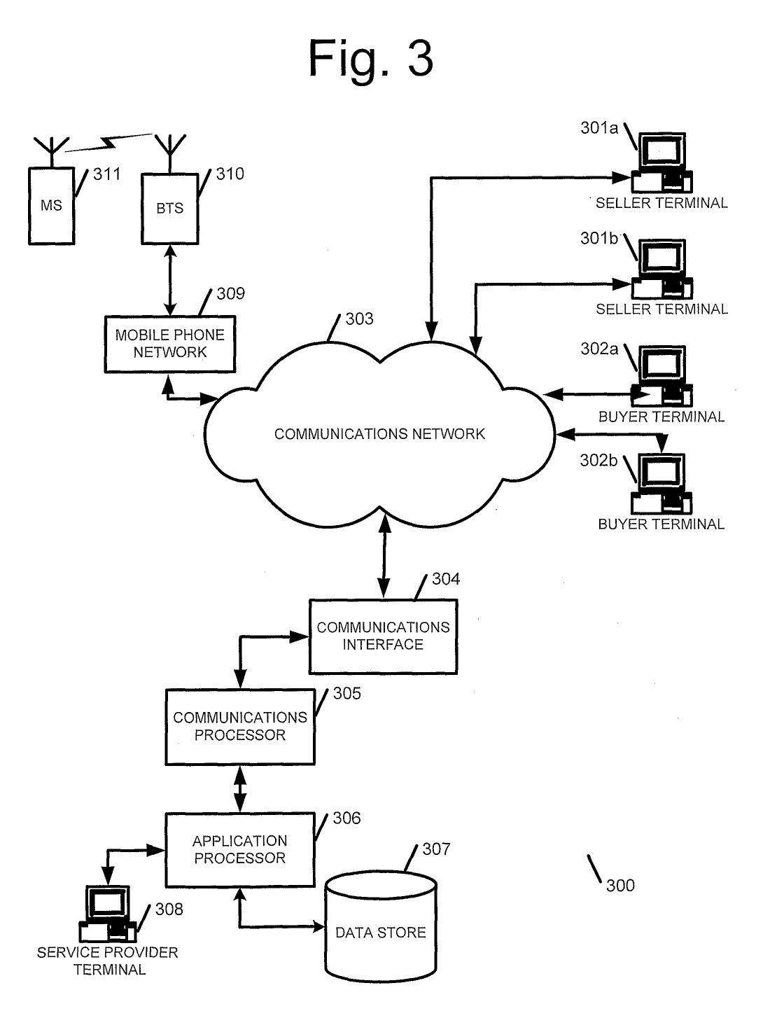

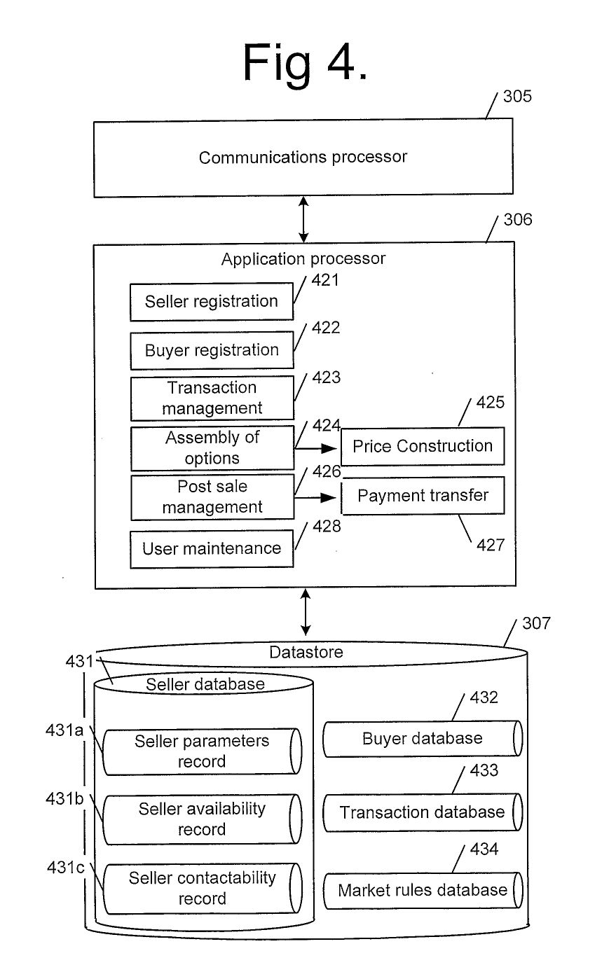

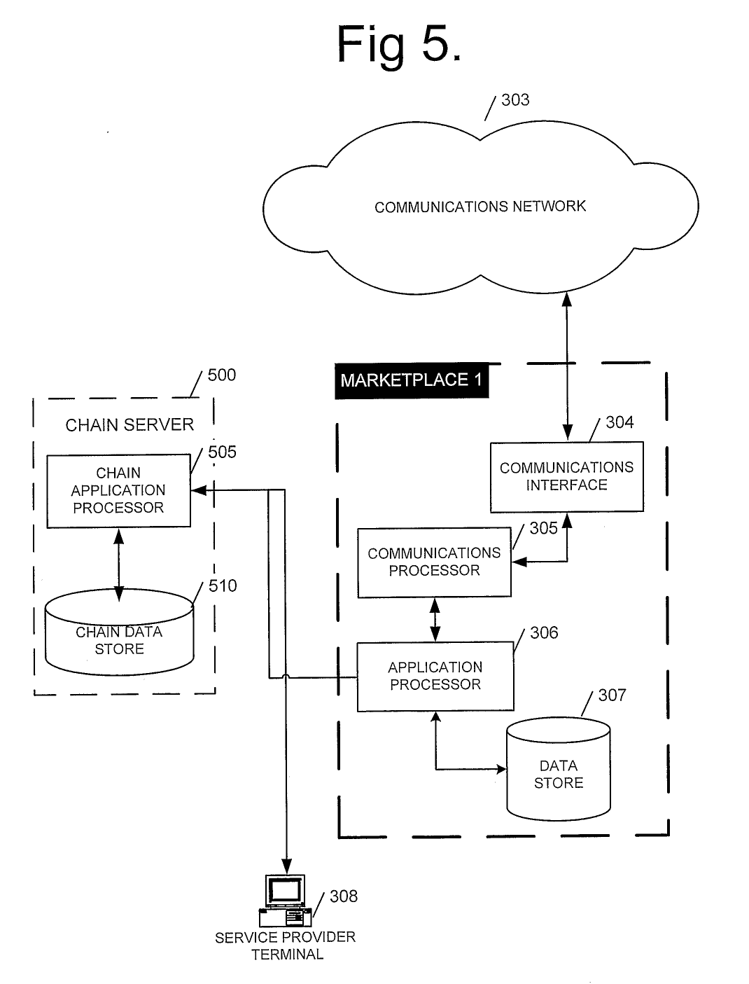

To return to the present example of a weekend away. It may be that the windsurfing lesson is Requirement 1 and the car valeting is Requirement 2: in this case there is no relationship between them by time or geography. That is; beyond narrowing the search for the entire weekend which will be reflected in the Cluster Tables, the options produced by the search for Requirement 1 will not limit in any way the options that can be searched for Requirement 2. It may then be that Requirement 3 is the solo windsurfing hire which has a relationship proscribed with the windsurfing lesson. This can now be translated from the original inputs. Thus, in column 1144 a for Requirement 3 the FIG. 1 is entered. At 1144b the relationship is translated into “at least 2 hours after”, that is this transaction must start after Requirement 1 has completed. Every requirement may have a start relationship to an already searched transaction and an end relationship to an already researched requirement, this is essential for journeys or deliveries: for example the bicycle hire delivery has a start relationship with the location at which the bicycle is located and an end relationship with the accommodation at which it is to be used. In the case of non “transit” requirements columns 1144 c and d are left blank.

Once section 1144 is completed Grid Assembly Module 615 checks for remaining chains that are part of the current buyer inputs and repeats the process in FIG. 9 from step 906 onwards for each. Thus it should be clear that a grid has been created which defines precise requirements for each requirement and dictates (a) the order in which they are to be searched (b) the way requirements for unsearched components are to be narrowed as the search progresses so the chain remains true to the buyer's inputs. Finally, at step 942 the search process can be triggered.

5) Searching Requirements Within the Grid

The process for turning the grid described above into a page of returns for the buyer will now be disclosed with reference to FIG. 13. The process is initiated at step 1302 by Grid Assembly Module 615 and performed by Non-Transit Search Module 625. At step 1304 section 1140 in FIG. 11c is read and the following cell is selected (a) the highest number search order that has been populated (b) the lowest number unsearched requirement.

At 1306 a table of options is created for this requirement and stored in Options Tables Store 665. It is given an identifying code based on (a) an identifier for this particular chain transaction (b) the search order being applied eg “01” (c) the number of the requirement within that search order as stored in column 1140a, 1140c or 1140 e and so on. A sample embodiment of this table is shown in FIG. 14 where 1402 shows the column headings and 1404 represents an infinite number of rows to be populated, one for each option returned by the search. The identifying code is entered into column 1306a and column 1306b identifies each specific option returned by the search.

As the search progresses from one requirement to the next the identifier from column 1406b is added to the chain code from column 1406a. Thus, each requirement in the table of options, as exemplified by FIG. 14, will itself create a table of options for further requirements. The final chain of options could be represented as a branch structure with an options table for the first requirement generating maybe five returns and therefore five options tables for the second requirement each of which then creates further options tables of their own and so on.

Returning to FIG. 13. Prior to searching this requirement, at step 1308, Non-Transit Search Module 625 establishes the parameters for a particular requirement. That is, it loads the list of permissible units contained within section 1142 of FIG. 11c. This information determines the criteria for the search, thus column 1142b contains a list of map references within which the transaction may start and, if it is a transit requirement, 1142d shows all the map references within which it may end. Likewise 1142f lists all the dates/times at which the transaction may begin. This information is stored as combinations: a date/time and the accompanying permissible map references.

The search is then initiated by (a) reading any already searched requirements which define a particular aspect of this requirement in section 1144 of FIG. 11c (b) looking up the available options already established for those defining requirements in the appropriate table in Options Tables Store 665 (c) treating each one of those options as a “root”, that is the new requirement must fit in with the start or end time or start or end geography of the previous requirement. It will need to do this while also limiting itself to what is tolerable within the information stored in section 1142 as described above. It might do this by taking each option revealed by (c) above and using each combination of times/geographies within section 1142 as the basis for a search of that requirement.

For example, returning to the weekend away, it may be that the overnight accommodation with sea view room is searched after the windsurfing hire and the windsurfing lesson. Thus, accommodation must be found within 10 miles of at least one hirer and 2 miles of at least one lesson provider. Additionally, the timescale in which it can occur is controlled by its cluster which has to reflect the availability of the housecleaning and car valeting in another cluster. Collectively these make up the inputs for the search. As will be known to those in the art the search can either use requirements consecutively, that is it (a) looks for all the accommodation within two miles of each seller in the lesson provider options table using the broad requirements established in section 1108 of FIG. 11a (b) checks which of those are also within at least 10 miles of a hirer listed for that requirement in Options Tables Store 665 (c) checks which of those options are within the permissible time/geography combinations stored in section 1142. Alternatively, the search can compute the overlapping areas/times that meet all requirements and then treat that as one set of inputs.

At step 1310, if this requirement is classed as a transit the more complex transit search process is instigated by Non-Transit Search Module 625. This is step 1312 and will now be described.

Searching for Transit Options Within a Chain

Journeys—of goods and people—are likely to be an integral part of chain transactions in “GEMs” type markets. Without this facility objects being hired could not get to the buyer's desired location unless delivery was arranged by the seller. Additionally, sellers needing to travel to complete a transaction would have to make their own arrangements outside the chain. As part of the present invention, there therefore exists a need for an underlying marketplace, to (a) take in offers to sell passenger journey or delivery capacity (b) construct a buyer's required transit, this may involve a sub-chain in which several providers are used in sequence to get a person or object to its destination.

Building of transit options must be an instantaneous part of the compilation of a chain and be included in facilities such as underwriting to protect the buyer against failure of a supplier. Furthermore, the market for transit provision must function as any other GEMs style market and be open to any seller inputting broad availability to sell and the numbers of people, or types and dimensions of goods they can transport. Individual buyers' specific requirements are then put together from within that availability.

The market for transit requirements contains two kinds of offering: (a) pre-determined transits; that is the seller inputs a commitment to run a vehicle between any number of geographic points with arrivals and departures at specified times this is stored as a list of map references of departure and arrival against timetabled dates/times of each, for example coach journeys, scheduled delivery trucks (b) commissioned transits; that is the seller inputs a geographic area (probably in the form of a radius of a their selected postalcode) within which they will provide an individual journey at the behest of a buyer, for example taxis or local delivery agents. This is stored as a pool of map references and times when the seller will be available for commissioned journeys. Times for journeys can be constructed by means of calculating the mileage and applying a formula for time taken to cover a mile. (A hybrid category such as service taxis is known in some countries. In this case, where a taxi will pick up passengers en-route the seller is treated as offering commissioned transits until their first buyer is obtained at which point the journey on which they are embarking becomes a pre-determined transit with any remaining seats available for sale on that basis).

Sellers in markets classed as transit will broadly specify as they input availability (a) which of the categories above is appropriate for their offering (b) if they are offering pre-defined transits their timetable, if commissioned then the pool of map references within which they will offer journeys (c) what form their carrying capacity takes; for instance passenger seats or refrigerated transport or covered loadspace in a van (d) their carrying capacity, that is how many seats or what size space they have to offer. They also input their rules for price construction.

A market for transit transactions additionally creates an opportunity for markets in (a) holding points, at which goods can be deposited between deliverers or held close to their intended recipient's location to await the recipient's availability (b) patches of land that are suitable as ad hoc embarking and disembarking points for long distance buses these can be offered to sellers of coach journeys who can schedule departures and arrivals between them. The flexibility with which resources can enter either market and have journeys routed to them enables continuous flexibility in the marketplace for travel of goods or individuals in “GEMs” style markets.

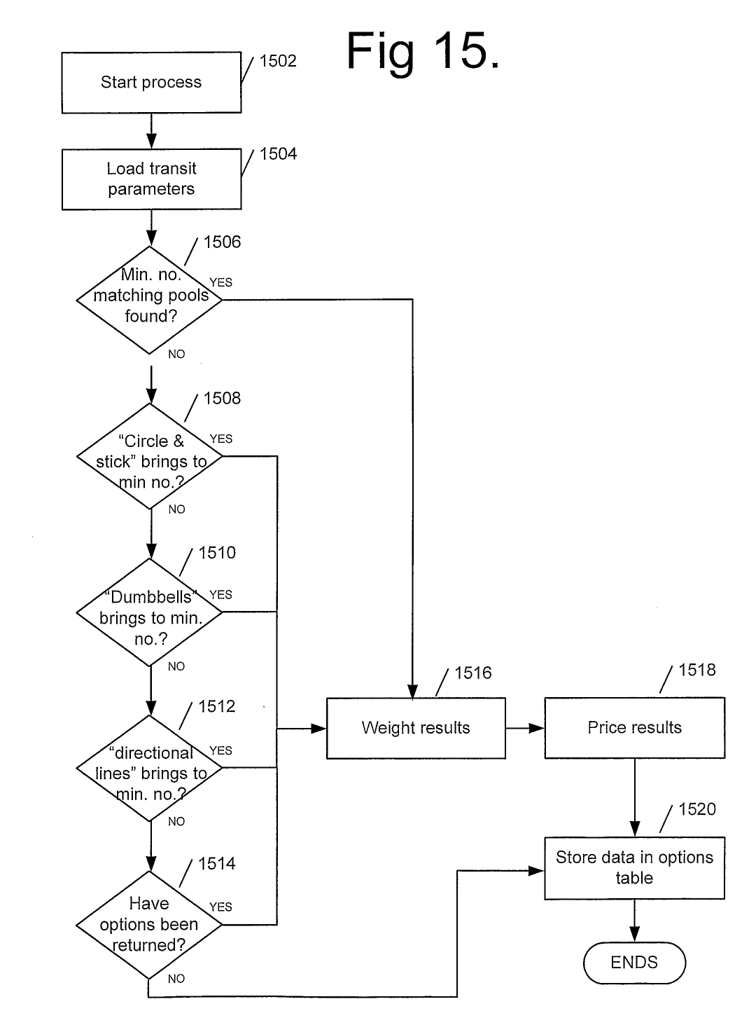

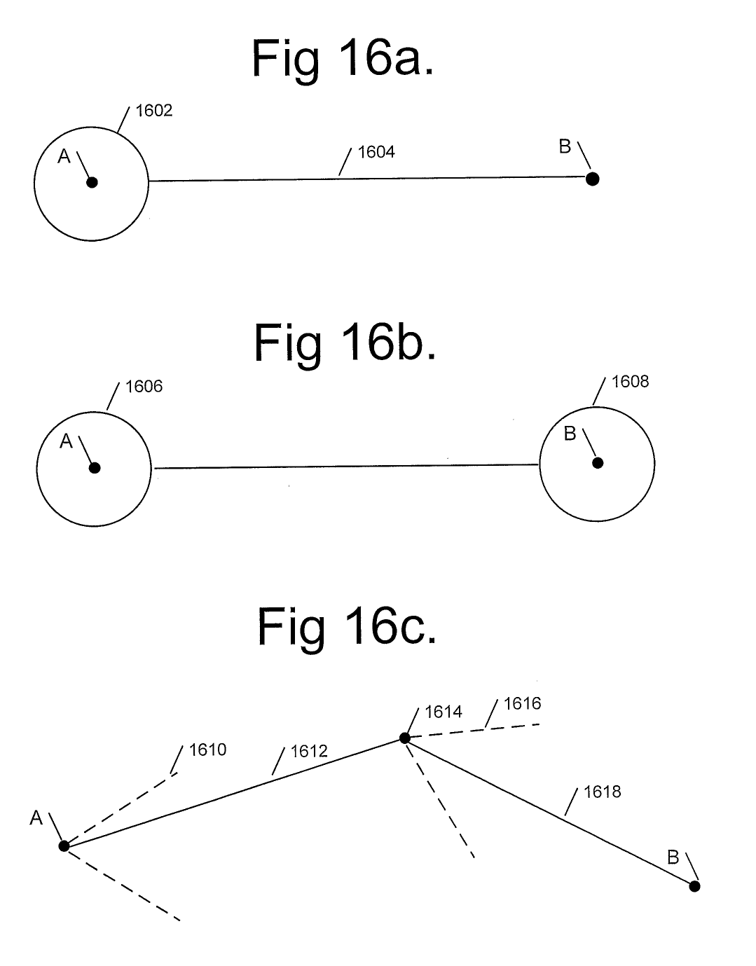

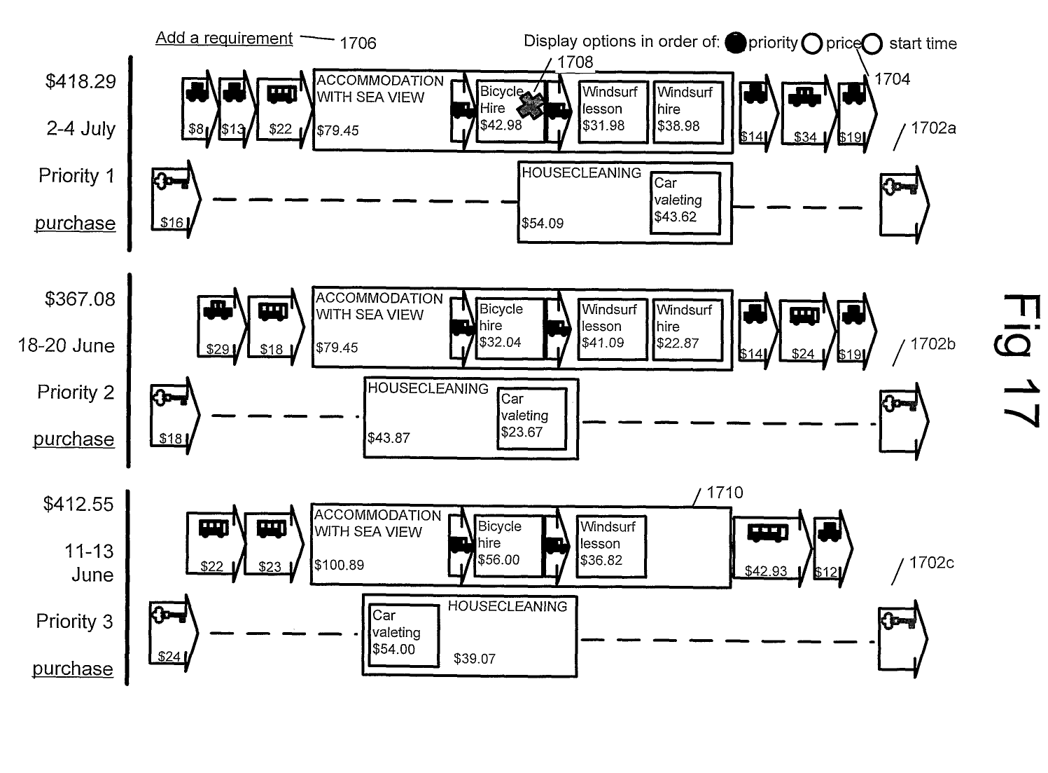

When a buyer's requirement involves a transit Non-Transit Search Module 625 triggers Transit Search Module 625, the process followed by the later will now be described with reference to FIGS. 15 and 16. FIG. 15 represents the process followed by Transit Search Module 625 in combining both pre-determined and commissioned transits in the best interests of the buyer while FIGS. 16a, 16b and 16c illustrate, in mapping terms, different kinds of transit that might be constructed between point A and point B where a straightforward match is not an option.

Turning first to FIG. 15. At stage 1502 the process is started. This requires inputs including (a) the start point and end point of the desired transit (b) what is to be carried (c) the number of people or items to be carried or the weight/shape of a load (d) the desired arrival or departure date/time. Said information is obtained from section 1108 of FIG. 11a and section 1142 of FIG. 11c. At step 1504 the current parameters for transit construction are extracted from Service Provider's Inputs Store 670. These include (a) the maximum pick-up/drop-off radius allowed; that is how far from the desired location can a transit begin or end, for example how far can a passenger be asked to walk from their specific map reference to begin a coach journey? This defines a small circle of map references around one pinpoint that become the arrival and departure point, any journey within this radius is deemed to not require a transit (b) minimum number of journey options considered suitable for a requirement.

At 1506 the system searches for any transit provider in the appropriate category with the required capacity and (a) availability to sell at the time required (b) the required map references within their pool. These could be either pre-determined or commissioned but are more likely to be the former for longer journeys. If the number of options found is at least equal to the figure loaded at step 1504 (b) then there is no need to search for more complex options and the system proceeds to calculate the price for each possible journey. If the minimum number is not met, at step 1508, Transit Search Module 625 attempts to create a “circle and line” journey as illustrated in FIG. 16a. That is, it (a) calculates all the map references within circle 1602 which marks a radius of perhaps 1 mile of the departure point (b) looks for any appropriate and available transit provider with any one of those map references and the arrival point enabling line 1604 to be constructed (c) repeats the process with a circle around the arrival point seeking a single provider to any of those map references from the departure point (d) if it makes such a match, it then creates a sub-requirement for a journey to/from the point in the circle at which the main journey begins or ends, the process of raising and storing sub-requirements will be explained later in this document (e) repeats the preceding four steps progressively widening the circle to perhaps 10 miles.

If this has not produced the required number of journey options, step 1510 requires the creation of a “dumbbell” pattern. This is illustrated in FIG. 16a and consists of circle 1606 around the departure point and 1608 around the destination. Again, these start with a small radius of perhaps a mile and expand progressively as Transit Search Module 625 searches for any transit provider that can carry the required goods or people between any point in one circle to any point in the other. If such a journey is found two sub-requirements are then created, one within each circle, to complete the transit from point A to point B.

If this has still not delivered the minimum number of journey the system moves to the most processing-intensive way of constructing a journey. This is termed “directional line” and illustrated in FIG. 16c. It involves the following steps: (a) angle 1610 is constructed with Point A as its apex, the angle is perhaps 20 degrees as defined at step 1504 (b) within that angle from Point A Transit Search Module 625 seeks the appropriate and available transit provider that will take the goods/people to be transported the furthest from Point A along line 1612 (c) at point 1614, the termination of line 1612, it creates another angle 1616 pointing towards Point B (d) it seeks to build line 1618 that is a single provider who will carry the goods/people to Point B with departure as soon as possible after estimated arrival at point 1614 (e) if it cannot build line 1618 it repeats the preceding 4 steps, and this step, until the destination is reached. In a further embodiment, the angle might be progressively widened if no matches above a certain journey length are found. In another further embodiment the process illustrated in FIG. 16c could be additionally run in reverse starting with Point B and working backwards to build journeys from Point A. It will be appreciated that the “directional line” method may result in a journey made up of (a) all pre-determined transits (b) all commissioned transits, for example a string of taxis each taking a passenger to the limits of their working area before handing over to another (c) any combination of the two. If this produces the required minimum of returns the options are sent for weighting.

Where a transit is for the carriage of goods rather than people, construction of a journey may involve the use of holding points between legs of delivery as described earlier. In these cases, the objects in transit can be taken to the available holding point nearest the desired destination for a particular leg and that then becomes the pick up point for the next leg at the earliest possible time after drop off.

If the steps 1506 to 1512 have produced results, but below the minimum number of returns, at step 1514 what returns have been recorded are sent for weighting. If it has produced none that is recorded and the process ends.

It is desirable that options produced by steps 1508, 1510 and 1512 are weighted for convenience. They could offer a plurality of options each involving multiple changes between transit providers, varying weighting times, differing deviations from the ideal route and so on. These options require sorting so the most desirable are presented to the buyer first. Therefore, at step 1516, Transit Search Module 625 weights the returns for their desirability. This might involve (a) ranking by number of legs in the journey by applying the following percentages to each option

| | | |
|---|---|---|
| 1 | leg | 100 points |
| 2 | legs | 75 points |
| 3 | legs | 50 points |
| 4 | legs | 40 points |
| 5 | legs | 30 points |
| 6 | legs | 25 points |
| 7 | legs | 20 points |
| 8 | legs | 15 points |
| 9 | legs | 10 points |
| 10 | legs | 05 points |
| 10+ | legs | 0 points |

(b) ranking similarly by percentage above the shortest total journey time among the options (c) ranking similarly by total time spent waiting between legs (d) ranking similarly by proximity to buyer's selected start and finish times (e) awarding points based on buyer's desired requirements such as at-seat catering during a coach journey. Additional procedures for further weighting are well known to those in the art. In a further embodiment a buyer would be able to over-ride the weighting tables with his own inputs. The points for each journey option are totalled and converted to a weighting factor stored in column 1418 of FIG. 14 as will be described later in this document.

When the transit is for an object(s) rather than a person or people, it is desirable that changeovers between delivery providers are made only through an authorised changeover point. That is, a point at which goods can safely be left until collected by the provider of the next leg of their journey. Thus, in delivery markets the pool of potential map references for any search may only include those in a given radius that show there will be an acceptable changeover point in operation at the time of the journey. The market for changeover points may be similar to that for holding keys described earlier in this document; anyone can provide this service at any time and may be promoted through market grades if they are continuously reliable. Their involvement in a journey might demand a further sub-requirement as part of the journey requirement.

At step 1618 each available option, including any sub-requirements, is priced by Price Construction Module 425 based on the seller's individual rules and at 1620 the options for a particular delivery or passenger journey are recorded in the options table shown by FIG. 14 as will be described later in this document.

Recording the Results of Searches

Returning to FIG. 13. Assuming the current requirement is not a transit, the search is performed, at step 1314, as outlined earlier in this document. Assuming inputs similar to those illustrated in FIG. 1 are needed it will be clear all the required information is stored within Buyers' Grid Store 660. The market in which a purchase is required is contained in the appropriate row of column 1108a in FIG. 11a. Similarly, column 1108d records any specific parameters of a seller's offering that must be matched. 1108e provides the number of units to be bought and, as outlined above, section 1142 within FIG. 11c determines the desired geography and start times. Likewise, the process by which a price for each seller might be constructed has been explained earlier.

At step 1316 the results are input into the table of options as illustrated by FIG. 14. This requires the following entries for each potential transaction produced by the search;

(a) seller identity in column 1408

(b) the location of the seller for this transaction in column 1410b and the end location in 1410b if they would be providing a transit

(c) start and finish times in 1410c and 1410d

(d) not all the options may be able to offer the full number of units, for example hours of hire, that the chain requires; 1412 therefore records the number of units this transaction would contain

(e) 1414 stores matches for buyer requirements that were input as “would like” in section 802c of the screen represented by FIG. 8

(f) as disclosed in application UK0406076.0 by the present inventor, sellers within “GEMs” type markets may be allowed to specify requirements about additional components of any transaction in which they are involved; for example a seller of housecleaning services may stipulate that they are not willing to work on a specific property while a named car valeting operative works for the same household. Alternatively chain controls might relate to the properties of a product being hired; in the agricultural equipment market for example a particular baler may require a tractor of certain horsepower before it can be used, if the tractor and baler are being hired together within a chain the tractor's engine size could be a chain control on that baler.

These factors have to be controlled within the search process shown by FIG. 13 and are deemed to be either “upchain”, that is the other component to which they relate has already been searched or “downchain”, the other component has not yet been searched. Column 1416a stores the presence of any upchain seller requirements and 1416b whether those requirements are met by the preceding transaction to which this search is linked (as stored in column 1406a), if not the transaction is deemed ineligible and removed from the available options. Column 1416c stores the presence of downchain requirements by this particular seller and 1416d the details that are then factored into further searches using this transaction as a root. An example of such a downchain requirement might be “will not work with seller number 564289”. It will be appreciated that section 1416 could expand to include a plurality of requirements by each seller.

(g) the price each seller would charge for fulfilling this buyer's requirement is stored within column 1418a with a weighting factor, as described below calculated and stored in 1418b and the resulting “effective price” calculation output in the appropriate row of column 1418c.

Weighting creates a ranking that favours potential transactions within a chain that are likely to make that chain more attractive for the buyer. For example, one parameter for rating may be on the number of times a particular seller has sold to the present buyer, as stored in Transaction Database 433 in the past with the “effective price” reduced for each occurrence. Thus, a seller who has transacted ten times with this buyer might have their effective price reduced by 50%, one who has sold five times might see a reduction of 25% and so on. Other parameters by which an individual potential transaction might be weighted include: (a) previous occurrence in this chain, using the example of the weekend away it may be that the windsurfer hire following the windsurfing lesson could be supplied by the same seller and this would be desirable for the buyer so the second occurrence is weighted (b) matches with buyer desirables as stored in section 1414 (c) matches with a buyer's personal record of preferences stored within the system, for example a fondness for vegetarian breakfast options at overnight accommodation (d) collaborative filtering to establish popularity of this option with other buyers purchasing comparable chains (e) number of units available as listed in column 1412 (f) seller's ranking in a table of points awarded to potential sellers by this individual buyer.

Widening or Narrowing the Number of Returns

At this point the store of available options for any requirement within Options Tables Store 665 may have very few returns. This would narrow the options for further transactions in the chain so much that there may be no sellers available for requirements still waiting to be searched. Alternatively, there may be so many returns that searching for the compatible requirements in the chain will require unrealistic amounts of processing power and produce numbers of returns that are unmanageable for the buyer. In a preferred embodiment of the present invention there is therefore a stage where the number of search options is either boosted or reduced if required. This will now be described.

Service Provider's Inputs Store 670 contains (a) a number of returns above which the options inserted into a chain need to be narrowed, for example 20 (b) a number of returns below which Non-Transit Search Module 625 will attempt to find additional returns to ensure sufficient choice for the buyer, and the likelihood of further dependant requirements in the chain being found, by way of example this figure might be 5. In a further embodiment these numbers could change based on their placing in the current search order, it is important to have more returns in the thinner markets at the beginning of the search. Thus, a rule could be the first 20% of requirements in a chain will handle between 30 and 50 returns, the second 20% will handle between 20 and 40 and so on.

At step 1318 the first of the above numbers is compared with the number of returns produced by the search. If it is above the stored figure, at stage 1320, a narrowing of options is applied. This might involve any of the following steps in any combination (a) retaining only the cheapest options in column 1418a (b) retaining only the “effective price” cheapest options stored in “column 1418c. The method to be applied will be stored in Service Provider's Inputs Store 670. After any narrowing the process moves to step 1328.

At step 1322, Non-Transit Search Module 625 checks against the stored number to see if the present table of options requires broadening. If so, at 1324, broadening rules are applied. This involves setting new parameters for a wider search by going back to change inputs in the grid. These changes could include (a) loosening the limitations ratio applied in column 1110a of FIG. 11a (b) removing the underwriting for this transaction so column 1126 in FIG. 11b shows that any grade of seller is eligible; when this happens the component is removed from the underwriting but all other components underwrite each other as before, the appropriate row of column 1126a in FIG. 11b is set at zero and all other calculations are performed as before (c) removing one or more “additional demands” by the buyer from column 1108d within FIG. 1 la (d) altering the market sector in column 1108a within FIG. 11a according to a table stored in Service Provider's Inputs Store 670 that provides back-up sectors, for instance if a minicab can not be located the system may search for “van and driver” hire using the same requirements and book the driver to deliver the passenger using the van as a taxi. After any of these actions, steps 1306 to 1322 within FIG. 13 are repeated to create a new options table.

If, at step 1322, the figure still requires broadening Non-Transit Search Module 625 might initiate one or more of the following (a) break up a requirement into two or more sub requirements, initially by time, thus if it can not find a 4 hour windsurfer hire as stipulated by the buyer it may search for two 2 hour hires within the allotted time and then repeat the search, these sub-requirements are stored as an extension to the appropriate row in the table illustrated by FIG. 14 with each becoming the root of the sub-requirement to its right so that in effect a chain-within-a-chain is created. Section 1418 only appears at the end of all sub requirements and is a totalling of all their data (b) return progressively to earlier requirements in the chain, starting with the most recent, and restore any options removed at step 1318 then repeat the search using inputs from the newly expanded range of root transactions (c) create a new search order within section 1140 of FIG. 11c with the present transaction at number one then restarting the process illustrated by FIG. 13. from step 1304 (d) skipping this requirement and proceeding to the next. The options to be followed, and the order in which they are to be attempted are dictated by Service Provider's Inputs Store 670. If (a), (b) or (c) are invoked a secondary search is then performed at step 1326.

At step 1328 the Cluster Tables and parameters for future searches are updated. This may require the following steps: (a) compare the returns with the list of combinations of times/geographies in the row relating to that requirement of section 1142 of the grid as illustrated in FIG. 11c (b) where a particular combination of time/geography did not produce a return in the table of options represented by FIG. 14 that combination is removed from the list (c) by reversing the relationship with the appropriate cluster stored in columns 1142a, 1142c (if applicable) and 1142 e the appropriate Cluster Table can be updated with a new box of time/geography combinations in section 1206 (d) any other Cluster Table with the newly updated cluster listed in box 1204a or 1204b can likewise update box 1206 with a new entry by translating its relationship to the updating cluster (e) section 1142 of the next requirement to be searched can then be populated.

At step 1330, Non-Transit Search Module 625 checks with section 1140 of FIG. 11c whether there are further requirements to search, if so it returns to step 1304. If there are not, the final compilation of the chain can be enacted.

It will be clear that (a) Options Tables Store 665 now contains a plurality of tables of options, as represented by FIG. 14, relating to the present chain (b) those tables are related through the code stored in column 1406a that has progressively built up from the various options in the chain on which a particular search was based (c) this can be visualised as an expanding branch structure where each table of options has generated further tables of options for the next requirement to be searched (d) some attempts to build the chain will not have got as far as the final requirement because they have been unable to complete some components based on the earlier results (e) every option in any table can be identified by a combination of the chain code in column 1406a and the option identifier in column 1406b.

In a preferred embodiment of the present invention Service Provider's Inputs Store 670 contains a preferred number of chain options to be provided to the buyer, possibly related to the number of requirements involved. For example, it may be that a request for a chain containing 10 original requirements should return only the 20 best chains that can be built. At step 1332 the most complete chains up to said number are identified and the entries in column 1418a for each is totalled. At step 1334 that process is repeated with the entries in column 1418c. This information is stored within Buyers' Grid Store 660. At 1336 the most complete chains up to number required are marshalled in order of earliest start date/time.

At step 1338 Buyer Inputs Store 655 is consulted to check if any additional chains that are part of this buyer request remain unprocessed. If so Grid Assembly Module 615 starts again at step 906 of FIG. 9. Once all chains have been searched the results are sent for display to the buyer via Communications Processor 305.

6) Display of Chain Options to the Buyer

FIG. 17 shows one embodiment of a screen displayed to the buyer in response to their screen input illustrated in FIG. 8a and 8b. Only three potential chains are presented, one each in sections 1702a, 1702b and 1702c.

Each chain is represented graphically in chronological order with transits represented by an arrow with the mode of travel shown by an icon. Turning to section 1702a as an example, the upper row of components represents one cluster and the lower row the other. The left hand side contains the total price of that chain, the dates/times it spans, its priority (how it ranks in terms of effective price) and the means of purchasing that chain.

The price for a particular component is shown within the appropriate box. In a preferred embodiment, the screen will use the location of boxes from left to right to illustrate the timing of particular components within each chain.

Within this screen the buyer can (a) in section 1704, change the way chains are displayed so that he views them in order of start date or actual price rather than priority which is their ranking by “effective price”, using weightings that balance price against what are believed to be his desired attributes (b) purchase any chain using “purchase” selection at the left hand side of each chain, he may not be allowed to purchase more than one chain because the same seller within the same time period may occur in multiple chains (c) click on any component of any chain to bring up further details of that seller, for example clicking on the key symbol will reveal the location of the local trader who is to hold the keys enabling housecleaning and car valeting within this chain (d) add a requirement to the chain by selecting line 1706 which brings up a blank requirements box as illustrated in FIG. 8a (e) click on any component of any chain to bring up the original requirements box and change his requirements or cancel that component (f) click on any component to view alternatives within the options table within Options Tables Store 665, any of which can be selected as a replacement.

If he activates (d), (e) or (f) above a limited version of the process of grid assembly and search is repeated with the new inputs. Grid Assembly Module 615 may attempt to simply remove any redundant requirement and add a new one as the last item to be searched. Thus the original chain stays substantially in place with only the new requirement searched within the parameters defined by other components. However, if this does not produce any returns it may need to repeat the entire process of grid construction and search. A new version of the screen shown by FIG. 17 is then presented.

The screen returned to the buyer should also communicate any abnormalities in a chain. By way of example; 1708 indicates a component that is not underwritten because the seller is too low a grade, if this chain is purchased it would therefore be the buyer's responsibility to ensure the seller delivered on her commitments. 1710 indicates a component that has had to be skipped in the search because no match for the requirements at that point could be found in an otherwise complete chain.

7) Purchase of a Chain

Once a buyer indicates that he wishes to purchase a particular chain the following actions are required: (a) each individual component is ordered as it would be for a single purchase with that seller's appropriate block of availability removed and transfer of monetary or other value instigated (b) the communication with each seller apprising them of this sale is modified to include information about any adjoining elements in the chain, for example the overnight accommodation provider will be told of the bicycle hire with delivery and collection times and service provider included. This requires the use of phrases such as “will be delivered to”, “you are to collect”, “expected at (time)” and “change to a new provider” sandwiched between basic details of other components within the chain and their suppliers or the chain buyer, this output may include labels for example of the buyer's name to go in a minicab windscreen or to be attached to the bicycle which will be collected and deposited at the overnight accommodation and may benefit from having the buyer's name attached (c) the required deductions may be made from an underwriting account and held until such time as the chain is deemed to have completed without complaint, in a further embodiment the cash transferred for this purpose may be progressively paid back, with appropriate fees paid, progressively as individual components are completed and any time allowed for complaints lapses (d) the buyer may be given a page listing all the components with times/locations and service provider details (e) in a preferred embodiment this process will automatically update any electronic diaries of the chain participants.

In a further embodiment this process may include the issue of identifying passwords within the seller notifications so for example the deliverer collecting the bike at the end of the accommodation period is able to prove to the landlord that he is genuinely part of the contractual chain because he has a password that also showed up on the landlord's notification

8) Alterations to a Chain After Purchase

After a chain has been purchased it may need to change either (a) before the first transaction has begun or (b) while the chain of transactions are in progress. It may need to change because the buyer has revised his requirements or because a seller or sellers in the chain have defaulted.

A buyer is able to attempt adding a requirement to an already purchased chain by accessing the screen shown in FIG. 17, which after purchase shows only the purchased chain and selecting line 1706. Grid Assembly Module 615 then adds that requirement to the grid with the relationships he has defined and the appropriate options tables to search for suitable components. Once one is purchased the grid—stored in Buyers' Grid Store 660—is then amended. The new addition can be factored into the underwriting by recalculation of column 1126a and 1126b with the additional costs of cover being added to the cost of the new component.

If a buyer wishes to subtract a component he may be charged a cancellation fee by the seller and the underwriting may be recalculated within columns 1126a and 1126b with surplus paid back early to the underwriting fund. Changing a requirement is simply treated as subtraction followed by addition.

As detailed earlier in this document, application GB 0329203.4 discloses how “GEMs” type markets might deal with a seller failure using a series of screens through which the buyer confirms that a transaction is not happening as it should, or a seller informs the system that they cannot complete as scheduled. The present invention covers the impact of failure of a transaction on a chain and requires an amended version of the process described in the earlier application. Where a chain has to be restructured because of seller failure, and assuming said chain is underwritten, the process might be as follows; (a) the buyer is asked to choose between (i) replacing the missing transaction with an identical one (ii) changing the parameters, for instance to make the replacement later to allow for plans that have had to change (iii) skip the failed transaction, possibly with some compensation from the underwriting fund, and leave the rest of the chain untouched.

If the buyer does want the missing component replaced, either at the same time/geography or with changes, Grid Assembly Module 615 might (a) retrieve the original grid for this chain from Buyers' Grid Store 660 and purchased options from Options Tables Store 665 (b) remove the failed transaction (c) add the new requirement as the last item to be searched and begin the search process at step 1304 of FIG. 13 with the process ending at step 1328 and the resulting table of options that are within the allowable sum for rescheduling, as stored in column 1126a of FIG. 11b, are displayed to the buyer without prices (c) if this produces a result that is acceptable to the buyer, underwriting cash is accessed to fund the new transaction (d) if that fails to produce any returns or an acceptable return, Grid Assembly Module 615 cancels any transactions, and their dependencies such as transits, that have not yet started that are deemed mobile or delivered in column 1124a in FIG. 11b, puts the new requirement into the top of the search order with the requirements just cancelled above it in their original order with any required transits added and reruns steps 1304 to 1340 in FIG. 13 with a modified display to show the transactions classed as fixed have not changed. By doing this the system is attempting to minimise buyer disruption by avoiding a change of fixed location (e) if that fails to produce an acceptable result then the new requirement is added to the original requirements and the grid building and search programme begins—for all transactions that have not yet started—at step 902 of FIG. 9 (f) non-required transactions are cancelled with the sellers informed and their availability to sell re-instated (g) cash is accessed from the appropriate underwriting funds to pay any cancellation charges and new transaction costs up to the limit allowable for the failed transaction within column 1126a in FIG. 11b. If the sum required is exceeded by the funds available, the buyer might be asked to pay the difference. Failure of a transaction can require the automatic construction of a sub-chain to handle the problem. Thus in the present example if the buyers arrived at their overnight accommodation to find it was not available they would inform the system which would then (a) find the nearest possible alternative that met their requirements once the relationship to other elements of the chain had been satisfied, for example the overnight accommodation has a relationship with the windsurfing lesson and windsurfer hire, then Grid Assembly Module 615 will populate section 1144 with data relating to those options before it begins the search (b) construct a transit if they request it to do so (c) change the parameters for the bicycle hire which may entail cancelling the existing booking and making a new one for the new place of accommodation (d) offers the buyer the opportunity of cancelling the scheduled windsurfing lesson and hire and having them replaced if they are outside his original parameters for the new accommodation.

In above described embodiments of the system the Internet, and more specifically web technology, is used for communication between a central computer system and the buyers and sellers. However, it is not necessary to implement the invention using the Internet and the system may, for example, be implemented on local or wide area networks, wireless mobile communications networks, cable tv networks and the like. Similarly, the terminals used by the buyers and sellers for communicating with the central computer system may comprise mobile phone handsets, personal digital assistants, inter-active televisions and the like.

Likewise, as it is well known to those skilled in the art, the processing for performing the functions described above may be shared between machines in ways other than that shown in the illustrated embodiments.

No doubt many other effective alternatives will occur to the skilled person and it will be understood that the invention is not limited to the described embodiments and encompasses modifications apparent to those skilled in the art lying within the spirit and scope of the claims appended hereto.

Other Means of Achieving the Present Invention

It will be clear to the person skilled in the art that some of the steps in the preceding description are included only for clarity and could be omitted in operation. Without being exhaustive, they include: (a) map references may be stored in section 1008b of FIG. 11 not as a list but as a formula (b) at step 1328 in FIG. 13 only data in the Cluster Table relevant to the next item to be searched may be updated rather than all tables being updated after every requirement is searched (c) step 916 and 918 in the process shown by FIG. 9 could be omitted with the buyer making changes only once the screen of options shown by FIG. 17 is presented.

Likewise the search of requirements could be performed in chronological order rather in order of thinness of the market. Equally all options could be searched simultaneously and then matches made among the returns. However, both of these techniques would be likely to require more processing of options in a chain made up of requirements from a variety of thin and thick markets.

Additional Embodiments

Advanced relationships embodiment:

The buyer's input box represented by FIG. 8a could be modified to allow more complex relationships between requirements in a chain. These relationships might include (a) “or” so the assembled chains are to include either Requirement E or Requirement F, this can be most thoroughly achieved by searching all options with Requirement E then all options with Requirement F before weighting (b) “same direction as” the buyer can specify that Requirement G is to be 30 miles from Requirement A and Requirement H is to be 50 miles from Requirement A but G and H are to be in the same direction from A. This is best achieved by constructing a relationship in the Cluster Tables (FIG. 12) in which box 1204c is able to ensure the map references populating section 1206 remain aligned by a formula plotting the relationship based on grid squares of a map (c) “within either”, section 804c of the input box represented in FIG. 8a is amended to include the means to stipulate the present requirement is to happen within one of a plurality of other requirements. Further rules will be immediately obvious to one skilled in the art.

Buyer's Qualitative Allocation Embodiments:

The buyer's input screen represented by FIG. 8a and FIG. 8b could be modified to include a facility for the buyer to allocate ratings to a range of requirements within a chain. Those ratings then form the basis for prioritising available options. This could be achieved by modifying the “number of units” input in section 802b to include a further “number of points” input. Thus a user would specify the market in which they wished to buy and then input a rating for that market before moving to the next requirement. For example: a buyer at an abattoir could allocate 5 points to a cow, 3 to a pig and 2 to a sheep then instruct Chain Server 500 to maximise the number of points it could buy relative to transport costs in purchases that day from surrounding farmers.

An individual buyer's rating could equally be applied to individual sellers. Thus the manager of a call centre might be able to call up a list of all the temporary workers available in her area and then allocate each between one and six stars. When inputting her requirements for a particular shift the manager is then able to either (a) instruct Chain Server 500 to maximise the number of stars purchased against total cost for that shift or (b) instruct the system to purchase minimum numbers of individuals with a defined number of stars, for example “3 staff with 4-6 stars, 10 staff with 2-3 stars, 25 staff with 1-2 stars. The later option is most useful when stars are used to denote seniority. The number of stars for a particular seller as awarded by a particular buyer may be stored in an additional module within Seller Database 431.

Option A above can be achieved by modifying column 1418b of the options table represented by FIG. 14. This enables number of stars allocated to a particular seller by that buyer (stored within Buyer Inputs Store 655) to become the dominant weighting factor. Option B above might be achieved by making each of the three distinct requirements for staff with a minimum number of stars a separate requirement.

Purchase Related Chain Assembly Embodiment

A seller in any one of the marketplaces underlying the present invention may wish to make sale of an offering dependant on a chain being constructed, for example to ensure security or delivery within their parameters. Thus someone making an office available in the office rental market might stipulate that it is only to be offered if (a) a security guard can be engaged for the duration of the booking (b) a key holder is available to take keys the previous evening and hand them over to the guard (c) a cleaner can be hired for an hour at the end of the booking. This is likely to be best achieved by allowing the seller to access a modified form of the input screen as shown in FIG. 8a and FIG. 8b and then input the requirements which must be completed before their offering may be displayed to a buyer.

Thus, if the relevant office is suitable for inclusion in a buyer's search then the seller's requirements for that office become the inputs for the chain which must be constructed before the room can be shown as an option for the buyer. If he then selects that office for purchase the chain is simultaneously purchased as detailed earlier in this document. Costs can be added to the sale price displayed to the office buyer or funded from a separate account according to the seller's wishes.

For the sake of clarity it should be explained that this process can result in a chain-within-a-chain. The buyer above may need the office as part of a wider chain and the office itself is part of a seller stipulated chain.

Automated Grid Creation Embodiment

The grid creation process illustrated in FIG. 9 may in some circumstances be usefully triggered automatically.

This could be beneficial if, for example, a market user could not find what they sought for a single requirement purchase. Chain Server 500 may, in the present embodiment, automatically break that single requirement into a chain and seek to most closely match the buyer's needs in this way.

Thus, by way of example, if a buyer sought two weeks of storage for his house contents and no options were returned the underlying marketplace might automatically trigger an automated grid assembly module. This might (a) break the requirement initially into two components, two blocks of one week of storage, and seek a chain which included transit between the two (b) if that failed break the requirement into three blocks and so on (c) where possible, break the requirement for quantity thereby seeking two storage units of half the original size for two weeks (d) breaking the quantity into even smaller units (e) a combination of the above (f) creating sub requirements for delivery between the final locations.

The rules governing this automatic construction of a grid could be more sophisticated than simply inserting a break point according to a pre-determined formula. They could include (a) reading market thickness for all permissible blocks of time, geography, and quantity if the need can be broken in this way, within the requirement as outlined at step 932 in FIG. 9 (b) isolating the point of market thinness, it may be for example that a particular event is creating a peak demand for short term storage locally within the two weeks (c) creating a sub-requirement specifically around the point of market thinness, for example the two days when the storage market has above disproportionate utilisation and the creation of further requirements either side of that with transport between them as a further set of requirements (d) the application of step 1322 in FIG. 13, or a wider geographical search, to the sub-requirement as the first requirement in a chain (e) completion of the rest of the chain from steps 1304 to 1340 within FIG. 13.

A further example of this embodiment can be given in the delivery market. If step 1312 in FIG. 13, the “transit search” is seeking to construct a journey made up of multiple collections or deliveries but can not find one supplier who will cover the entire route it would be able to (a) identify delivery sellers who will cover the largest number of locations required (b) in each case then construct sub-requirements to either bring items from the unserved locations to the required delivery point or to a point at which the core delivery seller is available to pick them up.

In a further embodiment of this facility there might be rules, for example on overlap or seniority of requirements. These may be stored in Service Provider's Inputs Store 670 but overwritten by individual buyers. Thus, if a buyer stipulates they want a French speaking secretary for four weeks at a given location and one is not available, the present embodiment may allow Chain Server 500 to break the requirement into two or more blocks of time, based on patterns of market thinness for that specific requirement, each of which could be completed by a different worker. There might then be a variable overlap period, starting at perhaps half a day, when each secretary is able to hand over to their replacement.

1. A transaction management system for managing the purchase of products and/or services by a buyer from sellers, the system comprising:
a data store for storing seller data comprising, for each of a plurality of sellers, a seller indentifier and seller offer data indicating at least one product and/or service offered for sale;
a program store storing processor implementable instructions; and
a processor coupled to the data store and to the program store fro implementing the stored instruction, wherein the stored instructions comprise instructions for controlling the processor to:
implement a buyer interface to received a purchase inquiry from a buyer, the purchase inquiry comprising purchase criteria for a plurality of product and/or service requirements including timing and/or geographical relationships there between;
output seller offer data for a plurality of groups of sellers, the sellers of each group together being able to meet the purchase criteria for the plurality of product and/or service requirements; and
receive a purchase request from the buyer accepting said offers of the products and/or services from one of the groups of sellers.

2. The system of claim 1, wherein the buyer interface is implemented to received a purchase inquiry for a diverse plurality of product and/or service requirement to be determined by the buyer.

3. The system of claim 2, wherein the data store is further for storing buyer data comprising, for each of a plurality of buyers, a buyer indentifier.

4. The system of claim 1, wherein the seller data further comprises, for each of the plurality of sellers, a seller grade dependent on at least one of a number of successfully completed transactions involving the seller and a number of disputed problem transactions involving the seller.

5. The system of claim 1, wherein the buyer interface is implemented across the Internet.

6. The system of claim 1, wherein the stored instructions further comprise instructions for controlling the processor to implement a seller interface to received the seller offer data indicating at least one product and/or service offered for sale from a seller.

7. The system of claim 6, wherein the seller offer data further indicates a plurality of selling criteria, the selling criteria indicating at least one buyer or at least one class of buyers to which the seller will not sell a product and/or service.

8. The system of claim 6, wherein the seller offer data further indicates a plurality of selling criteria, the selling criteria indicating at least one seller or at least one class of sellers with which the seller will not be grouped.

9. The system of claim 6, wherein the seller offer data further indicates a plurality of selling criteria, the selling criteria indicating at least one product or service or at least one class of product or service with which the seller's products and/or service will not be grouped.

10. The system of claim 6, wherein the seller interface implemented to provide the seller with timing and/or geographical relationship information for their products and/or services that have been purchase, the information providing timing and/or geographical relationships between the seller's products that have been purchase and/or services and other products and/or services.

11. The system of claim 6, wherein the seller interface is implemented across the Internet.

12. The system of claim 1, wherein the buyer interface is implemented to received at least one timing relationship between any of the product and/or service requirements from the buyer, each timing relationship being one of at, between, before, after, within and during the start and/or end times of at least one other product and/or service requirement.

13. The system of claim 1, wherein the buyer interface is implemented to receive at least one geographical relationship between any of the product and/or service requirements from the buyer, each geographical relationship being at or within a defined distance of at least one other product and/or service requirement.

14. The system of claim 1, wherein the buyer interface is further implemented to provide the buyer with a visual representation of the plurality of product and/or service requirements and the timing and/or geographical relationships there between.

15. The system of claim 1, wherein the stored instructions further comprise instructions fro controlling the processor to:
ascertain compliance data for determining whether each seller in the group of sellers is willing or able to comply with the purchase criteria; and
output compensation data for compensating the buyer if said compliance data indicates that one or more of the sellers in the group of sellers is not willing or able to comply with the purchase criteria for purchase products and/or services, such as products being unsupported products and/or services.

16. The system of claim 15, wherein said compensation data comprises data indicating a compensating offer of an alternative product and/or service for the buyer, to replace or supplement unsupported products and/or services, and wherein the stored instructions further comprise instructions for controlling the processor to implement the buyer interface to accept an offer of the alternative products and/or services based on the said compensation data.

17. The system of claim 16, wherein said compensation data further comprises data indicating compensating offers of alternative products and/or services for the buyer, to replace or supplement requested products and/or services having a timing and/or geographical relationship with the unsupported products and/or services, and for which the sellers are not willing or able to comply with purchase criteria that have changed as a consequence of the timing and/or geographical relationship with the unsupported products and/or services.

18. The system of claim 1, wherein the instructions for controlling the processor to output seller offer data comprise instructions for controlling the processor to sequentially search the seller offer data in the data store to ascertain sellers able to meet the purchase criteria for each of the product and/or service requirements having the timing and/or geographical relationships, the product and/or service requirement in smallest and largest markets being searched first and last respectively.

19. The system of claim 1, wherein the stored instructions further comprise instructions for controlling the processor to automatically generate further purchase criteria for the product and/or service requirements, the further purchase criteria being timing or geographical limitations based on historical sales or demand data for the respective product and/or service markets.

20. The system of claim 19, wherein the further purchase criteria are adaptive, the further purchase criteria being lowered to increase a number of sellers able to meet the further purchase criteria for a product and/or service requirement and raised to reduce the number of sellers able to meet the further purchase criteria for the product and/or service requirement, the lowering and raising of the further purchase criteria being dependant on predefined data stored in the data store.

21. The system of claim 1, wherein at least one of the product and/or service requirements is for transport to and/or from locations that are defined relative to the location of one or more of the other product and/or service requirements.

22. The system of claim 21, wherein the instruction for controlling the processor to output seller offer data comprises instructions for controlling the processor to search the seller offer data in the data store to ascertain sellers able to meet the purchase criteria for each of the transport requirements and, if no sellers are able to meet the purchase criteria for a transport requirement, transform the transport requirement into two or more related transport requirements having purchase criteria that can be met by one or more sellers.

23. The system of claim 6, wherein the seller interface is implemented to receive seller offer data indicating transport offered for sale by the seller, and wherein the seller offer data comprises a plurality of selling criteria, the selling criteria indicating a geographical area within which the transport may be proved, the selling criteria changing to indicate specific locations at which the transport may be provided once part of the transport has been purchased.

24. The system of claim 6, wherein the seller offer data further indicates a plurality of selling criteria, the selling criteria indicating products and/or services required by the seller for providing the products and/or service offered for sale, the seller's product and/or service requirement having timing and/or geographical relationship to the products and/or services offered for sale.

25. The system of claim 24, wherein the stored instructions further comprise instructions for controlling the processor to output seller offer data for a plurality of sellers, the sellers each being able to provide products and/or services required by the seller for providing the product and/or service offered for sale.

26. The system of claim 1, wherein the purchase criteria include a preference for at least one seller or at least one class of sellers from which the buyer would prefer to purchase products and/or services.

27. A method of managing the purchase of products and/or services by a buyer from sellers, the method comprising:
storing in a data store seller data comprising, for each of a plurality of sellers, a seller identifier and seller offer data indicating at least one product and/or service offered for sale;
implementing a buyer interface to receive a purchase inquiry from a buyer, the purchase inquiry comprising purchase criteria for a plurality of product and/or service requirements including timing and/or geographical relationships there between;
outputting seller offer data for a plurality of groups of sellers, the sellers of each group together being able to meet the purchase criteria for the plurality of product and/or service requirements; and
receiving a purchase receipt from the buyer accepting said offers of the products and/or services from one of the groups of sellers.

28. The method of claim 27, wherein the buyer interface is implemented to received a purchase inquiry for a diverse plurality of product and/or service requirements to be determined by the buyer.

29. The method of claim 27, further comprising storing in the data store buyer data comprising, for each of a plurality of buyers, a buyer indentifier.

30. The method of claim 27, wherein the seller data further comprises, for each of the plurality of seller, a seller grade dependent on at least one of a number of successfully completed transactions involving the seller and a number of disputed problem transactions involving the seller.

31. The method of claim 27, wherein the buyer interface is implemented across the Internet.

32. The method of claim 27, further comprising implementing a seller interface to received the seller offer data indicating at least one product and/or service offered for sale from the seller.

33. The method of claim 32, wherein the seller offer data indicates a plurality of selling criteria, the selling criteria indicating at least one buyer or at least one class of buyers to which the seller will not sell a product and/or service.

34. The method of claim 32, wherein the seller offer data further indicates a plurality of selling criteria, the selling criteria indicating at least one seller or at least one class of sellers with which the seller will not be grouped.

35. The method of claim 32, wherein the seller offer data further indicates a plurality of selling criteria, the selling criteria indicating at least once product or service or at least one class of product or service with which the seller's products and/or service will not be grouped.

36. The method of claim 32, wherein the seller interface is further implemented to provide the seller with timing and/or geographical relationship information for their products and/or services that have been purchased, the information providing timing and/or geographical relationships between the seller's products that have been purchased and/or services and other products and/or services.

37. The method of claim 32, wherein the seller interface is implemented across the Internet.

38. The method of claim 27, wherein the buyer interface is implemented to receive at least one timing relationship between any of the product and/or service requirements from the buyer, each timing relationship being one of at, between, before, after, within and during the start and/or end times of at least one other product and/or service requirement.

39. The method of claim 27, wherein the buyer interface is implemented to received at least one geographical relationship between any of the product and/or service requirements from the buyer, each geographical relationship being at or within a defined distance of at least one other product and/or service requirement.

40. The method of claim 27, wherein the buyer interface is further implemented to provide the buyer with a visual representation of the plurality of product and/or service requirements and the timing and/or geographical relationships there between.

41. The method of claim 27, further comprising:
ascertaining compliance data for determining whether each seller in the group of sellers is willing or able to comply with the purchase criteria; and
outputting compensation data for compensating the buyer if said compliance data indicates that one or more of the sellers in the group of sellers is not willing or able to comply with the purchase criteria for purchased products and/or services, such products being unsupported products and/or services.

42. The method of claim 41, wherein said compensation data comprises data indicating a compensating offer of an alternative product and/or service for the buyer, to replace or supplement unsupported products and/or services, and wherein the buyer interface is further implemented to accept an offer of the alternative products and/or services based on the said compensation data.

43. The method of claim 42, wherein said compensation data further comprises data indicating compensating offers of alternative products and/or services for the buyer, to replace or supplement requested products and/or services having a timing and/or geographical relationship with the unsupported products and/or services, and for which the sellers are not willing or able to comply with purchase criteria that have changed as a consequence of the timing and/or geographical relationship with the unsupported products and/or services.

44. The method of claim 27, wherein outputting seller offer data comprises sequentially searching the seller offer data in the data store to ascertain sellers able to meet the purchase criteria for each of the product and/or service requirements having the timing and/or geographical relationships, the product and/or service requirements in smallest and largest markets being searched first and last respectively.

45. The method of claim 27, further comprising automatically generating further purchase criteria for the product and/or service requirements, the further purchase criteria being timing or geographical limitations based on historical sales or demand data for the respective product and/or service markets.

46. The method of claim 45, wherein the further purchase criteria are adaptive, the further purchase criteria being lowered to increase a number of sellers able to meet the further purchase criteria for a product and/or service requirement and raised to reduce the number of sellers able to meet the further purchase criteria for the product and/or service requirement, the lowering and raising of the further purchase criteria being dependant on predefined data stored in the data store.

47. The method of claim 27, wherein at least one of the product and/or service requirements is for transport to and/or from locations that are defined relative to the location of one or more of the other product and/or service requirements.

48. The method of claim 47, further comprising searching the seller offer data in the data store to ascertain sellers able to meet the purchase criteria for each of the transport requirements and, if no sellers are able to meet the purchase criteria for the transport requirement, transforming the transport requirement into two or more related transport requirement having purchase criteria that can be met by one or more sellers.

49. The method of claim 32, wherein the seller interface is implemented to received seller offer data indicating transport offered for sale by the seller, and wherein the seller offer data comprises a plurality of selling criteria, the selling criteria indicating a geographical area within which the transport may be provided, the selling criteria changing to indicate specific locations at which the transport may be provided once part of the transport has been purchased.

50. The method of claim 32, wherein the seller offer data further indicates a plurality of selling criteria, the selling criteria indicating products and/or services required by the seller for providing the product and/or service offered for sale, the seller's product and/or service requirement having a timing and/or geographical relationship to the products and/or services offered for sale.

51. The method of claim 50, further comprising outputting seller offer data for a plurality of sellers, the sellers each being able to provide products and/or services required by the seller for providing the product and/or services offered for sale.

52. The method of claim 27, wherein the purchase criteria include a preference for at least one seller or at least one class of sellers from which the buyer would prefer to purchase products and/or services.

53. A computer software product arranged to cause a computer to execute the method of claim 27.

54. A computer readable recording medium having encoded thereon at least one program for performing the method of claim 27.
